(19) United States
(12) Patent Application Publication
(10) Pub. No.: US 2017/0023098 A1
(43) Pub. Date: Jan. 26, 2017

(54) POWER TRANSMISSION BELT

(71) Applicant: GATES CORPORATION, Denver, CO (US)

(72) Inventor: Donald J. Burlett, Oxford, MI (US)

(21) Appl. No.: 15/209,593

(22) Filed: Jul. 13, 2016

Related U.S. Application Data
(60) Provisional application No. 62/195,122, filed on Jul. 21, 2015.

(51) Int. Cl. F16G 1/06; C08J 3/22; C08L 23/16; F16G 1/28; F16G 5/04

(52) U.S. Cl. CPC F16G 1/06; F16G 1/28; F16G 5/04; C08L 23/16; C08J 3/226; C08L 2205/06; C08L 2310/00; C08J 2315/00; C08J 2347/00; C08J 2323/16; C08L 2205/03

(57) ABSTRACT

This disclosure describes systems and methods which utilize organoclays compounded with zinc acrylates to improve the performance of drive belts. In performing research on organoclays, the inventors created formulations and methods of compatibilizing organoclays with metal salts of α-β-unsaturated organic acids and incorporating the compatibilized organoclays into the belt compound so that the planar organoclay particles are substantially aligned with the longitudinal plane of the belt. This is shown to provide a) lower Mooney viscosity (resulting in greater ease of processing), b) higher stiffness (both tensile and dynamic) c) improved tear resistance, d) lower crack growth rate and e) nearly equivalent fatigue resistance in spite of the increased stiffness. This combination of traits in the belts created utilizing the organoclay/zinc acrylate technology described herein results in an unexpectedly improved belt.

### INTRODUCTION

A power transmission belt is a loop of flexible material used to mechanically link two or more rotating shafts. Belts may be used as a source of motion, to transmit power efficiently, or to track relative movement. Good belt compounds need to be inexpensive and easy to work with, but also result in a flexible belt with excellent wear properties. The relative performance of belt compounds is typically measured using tests that include the DeMattia, Mooney and Monsanto fatigue-to-failure tests.

While improved performance is desirable, improved performance in one metric alone (such as workability) to the detriment of other performance metrics is not sufficient. Therefore, to be considered a viable improvement, belt formulations must show improvements in one or more metrics without significantly decreasing the other performance metrics.

### SUMMARY OF THE INVENTION

This disclosure describes systems and methods which utilize organoclays compounded with zinc acrylates to improve the performance of drive belts. In performing research on organoclays, the inventors created formulations and methods of incorporating organoclays into rubber compounds with zinc acrylates so that the planar organoclay particles are substantially aligned with the longitudinal plane of the belt to provide a) lower Mooney viscosity (resulting in greater ease of processing), b) higher stiffness (both tensile and dynamic) c) improved tear resistance, d) lower crack growth rate and e) nearly equivalent fatigue resistance in spite of the increased stiffness. This combination of traits in the belts created utilizing the organoclay/zinc acrylate technology described herein results in an unexpectedly improved belt.

In one aspect, this disclosure describes a power transmission belt having an elastomeric belt body in which the elastomeric belt body includes an organoclay compatibilized using one or more maleated polymers, reactive silanes and metal salts of α-β-unsaturated organic acids. Such a power transmission belt may include one or more elastomeric compounds; a metal salt of α-β-unsaturated organic acids (MSA); a maleated polymer; a reactive silane; and the organoclay additive.

The foregoing has outlined rather broadly the features and technical advantages of the organoclay/zinc acrylate belt composition in order that the detailed description of the technology that follows may be better understood. Additional features and advantages of the technology will be described hereinafter. It should be appreciated by those skilled in the art that the conception and specific embodiment disclosed may be readily utilized as a basis for modifying or designing other structures for carrying out the same purposes. It should also be realized by those skilled in the art that such equivalent constructions do not depart from the scope of the invention as set forth in the appended claims. The novel features which are believed to be characteristic of the technology, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the technology created by the inventors.

### BRIEF DESCRIPTION OF THE DRAWINGS

In the accompanying drawings, which are incorporated in and form part of the specification, like numerals designate like parts.

FIG. 1 illustrates an embodiment of a method for manufacturing a belt with an organoclay additive;

FIG. 2 illustrates a portion of a multi-V-ribbed belt;

FIG. 3 illustrates a portion of a standard notched V-belt;

FIG. 4 illustrates a portion of a toothed belt;

FIG. 5 illustrates the Mooney viscosity data for organoclay masterbatch/ZDA in HNBR samples;

FIG. 6 illustrates the 10% tensile modulus data for organoclay masterbatch/ZDA in HNBR samples;

FIG. 7 illustrates the elongation at break data for organoclay masterbatch/ZDA in HNBR samples;

FIG. 8 illustrates the dynamic modulus data for organoclay masterbatch/ZDA in HNBR samples;

FIG. 9 illustrates the hardness data on the Shore A scale for organoclay masterbatch/ZDA in HNBR samples;

FIG. 10 illustrates the tensile strength data for organoclay masterbatch/ZDA in HNBR samples;

FIG. 11 illustrates the results of the tear properties test for organoclay masterbatch/ZDA in HNBR samples;

FIG. 12 illustrates the results of the DeMattia crack growth rate test for organoclay masterbatch/ZDA in HNBR samples;

FIG. 13 illustrates the results of the fatigue properties testing for organoclay masterbatch/ZDA in HNBR samples;

FIGS. 14A and 14B illustrate the Rheometer data for the organoclay masterbatch/ZDA in HNBR embodiments and the control compound;

FIG. 15 illustrates the Mooney viscosity response surface (3D) from design analysis for organoclay masterbatch/ZDMA in EPDM samples;

FIG. 16 illustrates the Tensile Modulus (10% strain, room temp.) response surface (3D) from Design analysis for organoclay masterbatch/ZDMA in EPDM samples;

FIG. 17 illustrates the dynamic modulus response surface (3D) from design analysis for organoclay masterbatch/ZDMA in EPDM samples;

FIG. 18 illustrates the DeMattia crack growth rate response surface (3D) from design analysis for organoclay masterbatch/ZDMA in EPDM samples;

FIG. 19 is a diagram of the Durability test;

FIG. 20 illustrates the Mooney viscosity data for organoclay masterbatch/ZDMA/ZnO embodiments in sulfur-cured samples;

FIG. 21 illustrates the 10% tensile modulus data for organoclay masterbatch/ZDMA/ZnO embodiments in sulfur-cured samples;

FIG. 22 illustrates the elongation at break data for organoclay masterbatch/ZDMA/ZnO embodiments in sulfur-cured samples;

FIG. 23 illustrates the dynamic modulus data for organoclay masterbatch/ZDMA/ZnO embodiments in sulfur-cured samples;

FIG. 24 illustrates the hardness data on the Shore A scale for organoclay masterbatch/ZDMA/ZnO embodiments in sulfur-cured samples;

FIG. 25 illustrates the tensile strength data for organoclay masterbatch/ZDMA/ZnO embodiments in sulfur-cured samples;

FIG. 26 illustrates the results of the tear properties test for organoclay masterbatch/ZDMA/ZnO embodiments in sulfur-cured samples;

FIG. 27 illustrates the results of the DeMattia crack growth rate test for organoclay masterbatch/ZDMA/ZnO embodiments in sulfur-cured samples; and

FIGS. 28A and 28B illustrate the Rheometer data for the organoclay masterbatch/ZDMA/ZnO embodiments in sulfur-cured samples.

### DETAILED DESCRIPTION

In elastomeric products such as drive belts, a primary elastomer, sometimes also referred to simply as the “rubber” and which may be a mixture of compounds, is the major component of the product. The term “rubber” refers to a material capable of recovering from large deformations quickly and forcibly, and which is essentially insoluble in boiling solvents (due the presence of covalent crosslinks). Specific additives are often given in amounts relative to the amount of rubber, typically using amounts in terms of parts per hundred parts of rubber (“phr”). Other useful definitions may be found in ASTM D-1566, which is hereby incorporated herein by reference.

Embodiments of the belts described herein incorporate an organically-modified clay additive into the rubber. Clays are particles of natural layered mineral aluminosilicates. Clay particles are typically planar along the dimension of the layers and have a thickness based on the number of layers in a particular particle. Clays include members of the smectite group, the vermiculite group, and/or the kaolin group. A common clay is montmorillonite.

Clays may be chemically modified, for example by treatment with quaternary ammonium salts, for use with polar polymers, such as nylon thermoplastics. Such modified clays are referred to herein as organoclays. An example of a suitable organoclay for use in creating organoclay masterbatch belt compositions is Nanomer I.44P from Nanocor. This organoclay is primarily montmorillonite that has been modified using a dihydrogenated tallow dimethyl ammonium salt as a surface modifier. The organoclay has a surface modifier concentration of about 34-36 wt %, a particle size of about 14-18 microns, and a specific gravity of about 1.5-2.0 grams/cubic centimeter. These organoclays have not found wide use with rubber, however, because the organoclays do not appear to disperse well in non-polar polymer matrices such as rubber and, especially, non-polar elastomers such as ethylene-based copolymer elastomers.

The work described herein shows that further compatibilization of organoclays, such as in the masterbatch process, and then incorporating the compatibilized organoclay into a non-polar polymer can improve the properties of a final product. For the purposes of this document, organoclay that has been further compatibilized using the compatibilizers described above or as described in greater detail below, e.g., further compatibilized using one or more maleated polymers, reactive silanes and metal salts of α-β-unsaturated organic acids, shall be referred to as the “organoclay masterbatch” in order to distinguish it from organoclay. Furthermore, it should be noted that “organoclay masterbatch” is not limited to organoclay that has been further compatibilized using a masterbatch, per se, but rather refers to organoclay particles that have been subjected to further compatibilization, including additional intercalation and/or exfoliation, regardless of method and, therefore, are more suited for use with non-polar elastomers. Intercalation refers to increasing the interlayer space between two layers of the natural mineral aluminosilicate, which can be achieved by exposing the organoclay to an intercalating additive such as stearic acid. Exfoliation occurs if the layers are completely separated, that is separated to the extent that there are no longer any interlayer interactions. Both intercalation and exfoliation expose more surface of the clay and also provide access for the large polymer chains to more of the organoclay. This disclosure describes that by treating the organoclay with additional compatibilizers, such as maleated polymers or reactive silanes, the nanomaterial effects of the organoclay on the final properties of the belt composition is improved. Without being held to any particular theory, it appears that treating the organoclay with the additional compatibilizers assists in the intercalation and exfoliation of the layers in the organoclay, resulting in more and thinner planar particles, possibly with improved dispersion within the non-polar polymer as well. While maleated polymers alone may compatibilize the organoclay sufficiently to improve the performance of an organoclay masterbatch belt compound, the further inclusion of reactive silanes in the masterbatch and of metal salts of a α-β-unsaturated organic acids (including zinc diacrylate and zinc dimethacrylate) in the final belt compound, as further discussed below, appear to provide even better performance of the resulting belt compounds.

In initial organoclay materials, such as Nanomer I.44P from Nanocor, the clay particles as supplied are agglomerates of many individual layers and are reported as roughly spherical particles with mean particle size of about 15-20 micron. However, the spacing between the individual aluminosilicate layers is larger than in the base clay. From this starting size, these agglomerates are presumed to be broken down (i.e., exfoliation occurs) as part of the further compatibilization that occurs during the mixing process with elastomer incursion which results in multiple ‘thinner’ particles having fewer layers. In addition, the elastomer may also enter the spacing between each aluminosilicate layers in forming a nanocomposite. This may result in some intercalation of the agglomerate particle. Without being bound to a particular theory, it is believed that the exfoliation and intercalation that presumably occurs during the further compatibilization allows the resulting thinner particles to be more effectively dispersed and bound into the final polymer and causing the improved properties observed herein.

The actual particle size distribution of compatibilized organoclay in the final product has not been characterized and is not exactly known. However, an average fundamental clay particle having a single layer is reported to be approximately 150 nm×150 nm×1 nm (or the lateral dimensions may be in the range of 100-200 nm). The number of fundamental particles remaining together as an agglomerate in the final rubber composition may be one, just a few or many. Based on this information, it is logical to conclude that the aspect ratio (diameter/thickness) of the platelets created from further compatibilizing organoclay particles may be in the neighborhood of 100 or so, giving meaning to the description of the plates as “thin.”

Although the examples below started with an organoclay in the form of a montmorillonite modified using a dihydrogenated tallow dimethyl ammonium salt, it is believed that any organoclay made from clays of the smectite group, vermiculite group, and/or kaolin group that have similar properties to montmorillonite could be compatibilized to create an organoclay masterbatch resulting in a belt compound with improved performance. In particular, organoclay masterbatch having one or more compatibilized members of the smectite group are believed to be suitable for use in belt compositions. The smectite group includes montmorillonite, aliettite, beidellite, ferrosaponite, hectorite, nontronite, pimelite, saliotite, saponite, sauconite, stevensite, swinefordite, volkonskoite, yakhontovite, and zincsilite.

Furthermore, the initial organoclay may be made by modifying clay using any suitable agent. In a particular embodiment, organoclay may be created by modifying clay using one or more quaternary ammonium salts. Suitable modifying agents include ammonium salts and, in particular, a dihydrogenated tallow dimethyl ammonium salt.

In addition to using organoclay masterbatch in a belt composition, the effects of two additional factors on organoclay belt compositions were investigated. The first factor was the effect of orientation of the planar particles of organoclay masterbatch on the final belt performance. This was investigated by aligning the planar particles of organoclay masterbatch in a final belt composition during manufacture so that the planes of the individual particles are substantially parallel to each other and substantially perpendicular to the radial axis of the belt.

The second factor, which was identified from an analysis of data created during investigation of the effect of aligning the planar particles, was the effect of varying the level of metal salts of α-β-unsaturated organic acids (“MSAs”), including zinc diacrylate and zinc dimethacrylate, in the final belt composition on the properties of an organoclay masterbatch belt composition.

As used herein, the MSAs suitable for use in organoclay masterbatch belt compositions includes the metal salts of α-β-unsaturated organic acids such as, for example, acrylic, methacrylic, maleic, ethacrylic, vinyl-acrylic acids and the like. These salts may be of zinc, cadmium, calcium, magnesium, sodium or aluminum, and are preferably those of zinc. In an embodiment, the preferred MSA's are zinc diacrylate and zinc dimethacrylate. The most preferred metal salt of unsaturated organic acid is zinc dimethacrylate for ethylene-copolymer elastomers or zinc diacrylate for nitrile-based elastomers. Amounts of the MSA useful in the belt compositions may range from about 1 to about 40 phr or 30 phr, and are preferably from about 5 to about 20 phr.

As shown in greater detail below, belts created using organoclay masterbatch belt compositions in which the planar particles of the organoclay masterbatch have been aligned within the belt exhibited improved performance. In addition, performance of the belts could be further manipulated by adjusting the relative amounts of MSAs in an organoclay masterbatch belt composition. Without being bound to any particular theory, it is believed that the MSA may provide additional surface modification to the organoclay masterbatch and/or may provide beneficial dispersion properties to the organoclay masterbatch in the final belt composition, leading to the surprising combination of properties shown in the finished products.

As a result of the investigations, the following organoclay masterbatch/zinc acrylate belt compositions have been identified as suitable for use in rubber articles and particularly in power transmission belts: one or more elastomeric compounds; an MSA, such as zinc dimethacrylate and zinc diacrylate; a maleated polymer such as maleated polybutadiene; a reactive silane such as triethoxy-vinylsilane; and an organoclay additive, wherein planes of the individual particles of organoclay masterbatch are substantially parallel to each other and substantially perpendicular to the radial axis of the belt.

In one particular embodiment zinc dimethacrylate (ZDMA) and/or zinc diacrylate (ZDA) may be utilized in such compositions in amounts ranging from about 1 to about 50 phr; or alternatively of from about 5 to about 30 phr; or of from about 10 to about 25 phr. The aligned organoclay masterbatch is in amounts greater than about 1 phr, but amounts greater than 2, 4, 8, 16, 32, or even 50 phr may be beneficial. In terms of ranges, belt compositions having aligned organoclay masterbatch in amounts ranging from about 1 to about 16 phr, or alternatively 2 to 12 phr or 4 to 8 phr may have particular value.

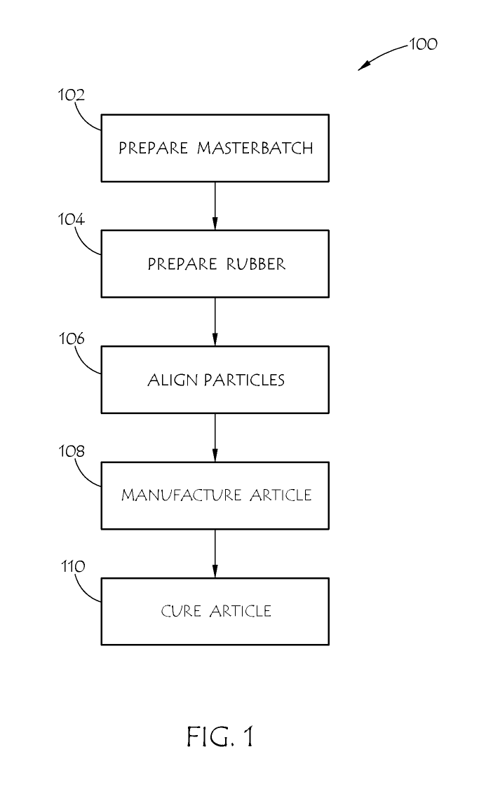

For the purpose of further explanation, the general method of manufacturing a belt from an organoclay masterbatch belt composition will now be described. FIG. 1 illustrates an embodiment of a method for manufacturing a belt with an organoclay masterbatch additive. The term “masterbatch” refers to a preliminary rubber composition, generally containing a relatively high concentration of a key ingredient, which can subsequently be added to (or to which subsequently may be added) additional elastomer and ingredients, leading to a final rubber composition resulting in a lower level of the key ingredient.

The masterbatch used to create the organoclay masterbatch/MSA belt compositions can be generally described as having the following formulation: a carrier polymer; a maleated polybutadiene; a vinylsilane that acts as a coupling agent; and the organoclay. In the embodiment 100 shown, a masterbatch containing an organoclay is created in a masterbatch mixing operation 102. It is in this operation 102 that the properties of the organoclay are changed through the interaction of the compatibilizing ingredients. In one embodiment of the masterbatch mixing operation 102, an organoclay additive and one or more other additives such as a hydrogenated nitrile butadiene rubber (HNBR), EPDM, zinc acrylate, a maleated polybutadiene, and a vinylsilane as described above are mixed.

A rubber composition is created in a rubber mixing operation 104. In an embodiment, the rubber compound includes an MSA. The resulting organoclay masterbatch belt composition has organoclay particles dispersed relatively uniformly throughout the polymer. The masterbatch may be added during the rubber mixing operation 104 to obtain a final composition.

In an alternative embodiment of the method, the masterbatch mixing operation 102 may be omitted and all the ingredients may be mixed together in the rubber mixing operation 104 as a single operation. In this embodiment (not shown), the organoclay is further compatibilized in the rubber compound during the mixing operation 104, although without using a masterbatch, per se. An investigation of this alternative indicated that it would appear that the modulus is slightly higher for the pre-masterbatched version of the compound than for just adding all these components in a single mixing operation 104. The observed effect was not major. This leads to the conclusion that there is a slight advantage to masterbatching, and primarily in the observed modulus.

Suitable elastomers that may be utilized as the rubber composition for belts include for example polyurethane elastomers (including as well polyurethane/urea elastomers) (PU), polychloroprene rubber (CR), acrylonitrile butadiene rubber (NBR), hydrogenated NBR (HNBR), styrene-butadiene rubber (SBR), alkylated chlorosulfonated polyethylene (ACSM), epichlorohydrin, polybutadiene rubber (BR), natural rubber (NR), and ethylene alpha olefin elastomers such as ethylene propylene copolymers (EPM), ethylene propylene diene terpolymers (EPDM), ethylene octene copolymers (EOM), ethylene butene copolymers (EBM), ethylene octene terpolymers (EODM); and ethylene butene terpolymers (EBDM); ethylene vinylacetate elastomers (EVM); ethylene methylacrylate (EAM); and silicone rubber, or a combination of any two or more of the foregoing.

The mixing of the rubber compositions may be carried out using any of the known methods or equipment for mixing rubber compounds, including internal mixers, extruders, rubber mills, and the like.

The elastomer(s) may be blended with conventional rubber compounding ingredients including fillers, plasticizers, stabilizers, vulcanization agents/curatives and accelerators, in amounts conventionally employed. For example, for use with ethylene-alpha-olefin elastomer, unsaturated diene elastomers such as NBR or SBR, and saturated diene elastomers such as HNBR, one or more MSAs may be employed in amounts now conventionally utilized to improve dynamic performance of the resultant article. Thus ZDMA and/or ZDA may be utilized in such compositions. These materials furthermore contribute to the adhesiveness of the composition, and increase the overall cross-link density of the polymer upon curing with peroxide or related free-radical cure agents through ionic crosslinking. Preferably the rubber compositions are peroxide cured or cured by another free-radical mechanism.

Regarding EPDM sulfur-cured systems, preliminary experiments indicate the organoclay masterbatch is also effective in this polymer matrix.

In addition, as described in greater detail below, it has been determined that the concentration of MSAs, specifically ZDMA and ZDA, in the rubber change the effects of the organoclay masterbatch on the performance of an organoclay masterbatch belt. That is, for any given organoclay particle concentration in the final belt compound, to achieve the best belt performance there may be an optimum amount or range of MSA to be used in the rubber. Likewise, for a given amount of MSA there may be an optimum amount or range of organoclay outside of which performance of an organoclay masterbatch belt is reduced or no longer improves. Therefore, the amount of MSA selected for a composition may be based on the amount of organoclay additive to be used or vice versa. Thus, the amount of organoclay additive to be used in the masterbatch may be selected based on the amount of MSA in the rubber composition. Alternatively, the amount of MSA in the rubber may be selected based on the amount of organoclay in the masterbatch. Alternatively, the optimum performing (on a given performance metric) combination of MSA and organoclay masterbatch concentrations may be used.

One skilled in the relevant art would readily appreciate any number of suitable compositions for utilization in or as the elastomeric portions of the belt. A number of suitable elastomer compositions are described for example in The R. T. Vanderbilt Rubber Handbook (13^{th} ed., 1996), and with respect to EPM or EPDM compositions and such compositions having particular high tensile modulus properties, are furthermore set forth in U.S. Pat. Nos. 5,610,217, and 6,616,558 respectively, the contents of which, with respect to various elastomer compositions that may be suitable for use in the formation of power transmission belt body portions, are specifically incorporated herein by reference. To any of these rubber formulations, the organoclay additive may be added to improve flex fatigue properties or crack growth resistance.

The final belt composition is then processed in an alignment operation 106. In the alignment operation 106 the final composition is worked to substantially align the planar of particles of organoclay masterbatch in a selected orientation. For example, in an embodiment the alignment operation 106 may be applied to the final composition so that the planes of the individual particles are substantially parallel to each other within the composition. Alignment of the organoclay masterbatch particles can be achieved by subsequent processing of the rubber, for example, by milling and/or calendering. By passing the rubber through one or more nips between a pair of rollers, the rubber may formed into a relatively thin sheet with the plate-like nano-clay particles tending to align in the plane of the rubber sheet. Other aligning methods are possible and any suitable method may be used. The word “substantially” is used herein to remind the reader that perfect orientation of the plane of each particle of organoclay masterbatch is not possible with current manufacturing techniques.

The alignment operation 106 may substantially align the particles of organoclay masterbatch in any orientation appropriate for the desired final belt properties. Different orientations will vary the final properties, such as wear resistance and crack growth in different axes.

After the alignment operation 106, the power transmission belt is formed in a belt manufacture operation 108. In the belt manufacture operation 108, which is generally described in greater detail below, the power transmission belt is formed so that the planes of the individual organoclay masterbatch particles are substantially parallel to each other and substantially perpendicular to the radial axis of the power transmission belt. Another way to say this is that the planar organoclay particles are parallel to the direction of travel of the belt and parallel to the width (or the axial direction) of the belt. The belt is then cured in a curing operation 110.

The organoclay masterbatch belt compositions created herein resulted in a belt compound that showed a) lower Mooney viscosity (resulting in greater ease of processing), b) higher cured stiffness (both tensile and dynamic) c) improved tear resistance, d) lower crack growth rate and e) nearly equivalent fatigue resistance in spite of the increased stiffness.

FIGS. 2-4 illustrate examples of various belts that could be manufactured using the organoclay masterbatch belt composition described above. Referring now to FIG. 2, a portion of a multi-V-ribbed belt 10 is shown generally. The multi-V-ribbed belt 10 includes an elastomeric main belt body portion 12, or undercord, and a sheave contact portion 14 positioned along the inner periphery of the main belt body portion 12. The word, “sheave” as used in this context includes conventional pulleys and sprockets used with a power transmission belt, and also rollers and like mechanisms. As illustrated, the belt 10 has a circumferential axis “C”, which is the direction of travel of the belt when in operation. The belt is designed to be strong but flexible along the circumferential axis and stiff in the width or transverse direction “W”. The direction through the thickness of the belt is called the radial axis “R” since the belt is generally made in an endless, circular loop. The radial axis is also radial with respect to a pulley on which the belt is wrapped.

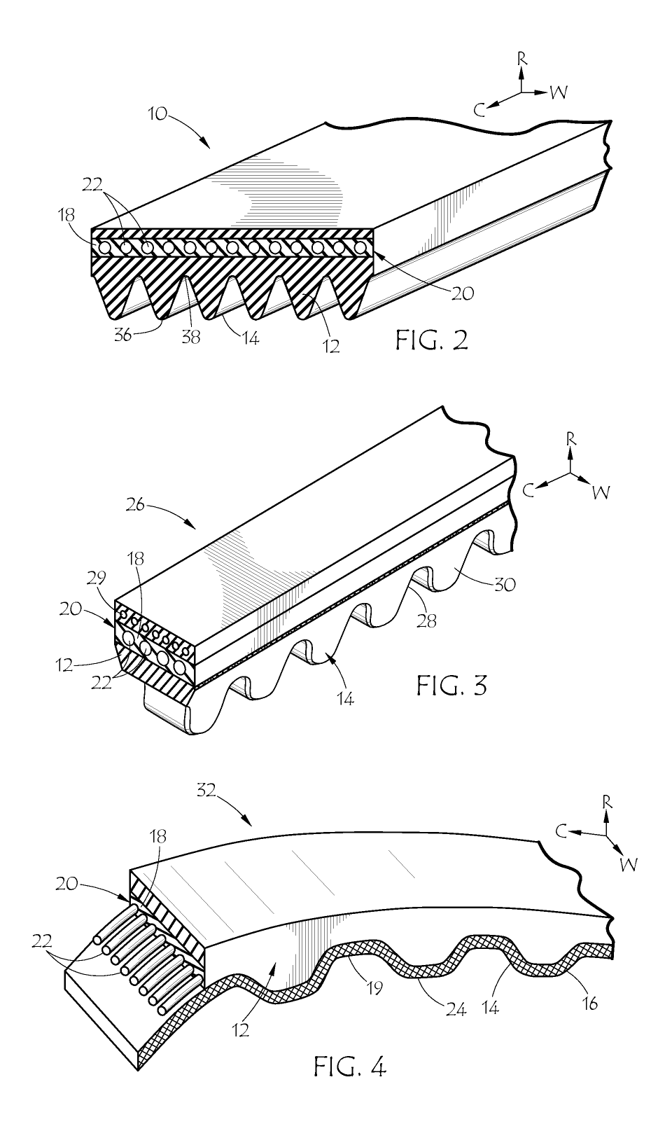

The particular sheave contact portion 14 of the belt of FIG. 2 is in the form of a plurality of ribs comprising raised areas or apexes 36 alternating with a plurality of trough areas 38 defining there between oppositely facing sides. In each of the instances of FIGS. 2-3, the sheave contact portion 14 is integral with the main belt body portion 12 and may be formed from the same elastomeric material(s) as described below. In FIG. 4 however, the sheave contact portion 14 can be seen to comprise a reinforcing fabric 24, explained in further detail below, as conventionally utilized in synchronous belt building configurations, and is thus formed of a material other than that of the main belt body portion 12 in that embodiment.

A tensile or load-carrying cord section 20 is positioned above the undercord 12 for providing support and strength to the belt 10. In the illustrated form the tensile section comprises at least one longitudinally-extending (that is, extending substantially parallel to the circumferential axis of the belt) tensile cord 22, described in further detail below, aligned along the length of the belt, and in some embodiments, is at least partially in contact with or is embedded in an adhesive rubber member 18 described in further detail below. The skilled practitioner would readily appreciate that in the several FIGS. 2-4, the adhesive rubber member 18 is illustrated in exaggerated form in order to visually distinguish it from the other elastomeric portions of the belt. In actuality, the cured composite is frequently visually indistinguishable from the surrounding elastomeric belt body portion except in cases, e.g., where one and not the other of the adhesive rubber member 18 and the undercord 12 is fiber loaded. Depending on the embodiment, the adhesive rubber member 18 may or may not be of the same material as the elastomeric main belt body 12.

A reinforcing fabric (not shown in FIG. 2) may optionally be utilized and in the case of V-belts and multi-V-ribbed belts intimately fits along the surface of the belt opposite the sheave contact portion 14 to form a face cover, or overcord, for the belt. The fabric may be of any desired configuration such as a conventional weave consisting of warp and weft threads at any desired angle, or may consist of warp threads held together by spaced pick cords as exemplified by tire cord fabric, or of a knitted or braided configuration, or of a nonwoven configuration, or paper, or plastic film, and the like. The fabric may be friction- or skim-coated with the same or different elastomer composition as that of the elastomeric main belt body 12. More than one ply of fabric may be employed. If desired, the fabric may be cut or otherwise formed to be arranged on a bias so that the strands form an angle with the direction of travel of the belt. One embodiment of such reinforcing fabric use is shown in FIG. 3 wherein a rubber-skim coated tire cord fabric 29, is illustrated in exaggerated form. Usage of nonwoven or paper materials is described for example in U.S. Pat. No. 6,793,599 to Patterson et al., and the contents of that patent with respect to same are incorporated herein by reference. Usage of plastic film is described for example in U.S. Pat. Application Publication No. 20020187869, and the contents of that publication with respect to same are incorporated herein by reference.

Referring to FIG. 3, a portion of a standard notched V-belt 26 is illustrated. As illustrated, the belt 26 has a circumferential axis “C”, which is direction of travel of the belt when in operation, a radial axis “R”, and a transverse axis “W”. The V-belt 26 includes a main elastomeric belt body portion 12 similar to that illustrated in FIG. 2, and a tensile or load-carrying section 20 in the form of one or more tensile cords 22 embedded in an optional adhesive rubber member 18, also similar to that illustrated in FIG. 2. The main elastomeric belt body portion 12, adhesive rubber member 18 and load-carrying section 20 of the V-belt 26 may be constructed from the same materials as described above for FIG. 2.

The V-belt 26 also includes a sheave contact portion 14 as in the multi-V-ribbed belt 10 of FIG. 2. The side surfaces of the elastomeric main belt body portion 12, or in the case of a V-belt as illustrated, of the compression section, serve as the driving surfaces of the belt 26. In the embodiment illustrated, the sheave contact portion 14 is in the form of alternating notch depression surfaces or troughs 28 and toothed projections 30. These alternating depression surfaces 28 and projections 30 may preferably follow a generally sinusoidal path as illustrated which serves to distribute and minimize bending stresses as the sheave contact portion 14 passes around pulleys during operation.

While in the illustrated embodiment, the V-belt 26 is in the form of a raw-edged belt, a reinforcing fabric 29 as described above may moreover be employed, either as a face cover or overcord for the belt as shown, or fully encompassing the belt to form a banded V-belt.

Referring to FIG. 4, a portion of a toothed belt 32 is illustrated. Again, the belt 32 has a circumferential axis “C”, which is direction of travel of the belt when in operation, a transverse axis “W”, and a radial axis “R”. The toothed belt 32 includes a main elastomeric belt body portion 12 and sheave contact portion 14 as in the case of the belts of FIGS. 2 and 3, and also includes a load-carrying section 20 as previously described for the belts of FIGS. 2 and 3. For the synchronous belt 32 however, the sheave contact portion 14 is in the form of alternating teeth 16 and land portions 19. A reinforcing fabric 24 as furthermore described above for the belts of FIGS. 2 and 3 may also be utilized and in this case intimately fits along the alternating teeth 16 and land portions 19 of the belt 32 to form a face cover therefor.

To form the elastomeric belt body portion 12, the elastomer(s) may be blended with conventional rubber compounding ingredients including fillers, plasticizers, stabilizers, vulcanization agents/curatives and accelerators, in amounts conventionally employed. For example, for use with ethylene-alpha-olefin elastomer, unsaturated diene elastomers such as NBR or SBR, and saturated diene elastomers such as HNBR, one or more MSAs may be employed to improve dynamic performance of the resultant article. These materials furthermore contribute to the adhesiveness of the composition, and increase the overall cross-link density of the polymer upon curing with peroxide or related free-radical cure agents through ionic crosslinking. Preferably the rubber compositions are peroxide cured or cured by another free-radical mechanism.

One skilled in the relevant art would readily appreciate any number of suitable compositions for utilization in or as the elastomeric portions of the belt. A number of suitable elastomer compositions are described for example in The R. T. Vanderbilt Rubber Handbook (13^{th} ed., 1996), and with respect to EPM or EPDM compositions and such compositions having particular high tensile modulus properties, are furthermore set forth in U.S. Pat. Nos. 5,610,217, and 6,616,558 respectively, the contents of which, with respect to various elastomer compositions that may be suitable for use in the formation of power transmission belt body portions, are specifically incorporated herein by reference. To any of these rubber formulations, the organoclay additive may be added to improve flex fatigue properties or crack growth resistance. In a belt embodiment associated with automotive accessory drive applications, the elastomeric belt body portions 12 may be formed of a suitable ethylene alpha olefin composition, such as an EPM, EPDM, EBM or EOM composition, which may be the same or different composition as that employed as the adhesive rubber member composition.

The elastomeric main belt body portion 12 may moreover be loaded with discontinuous fibers as is well known in the art, utilizing materials such as including but not limited to cotton, polyester, fiberglass, aramid and nylon, in such forms as staple-or chopped fibers, flock or pulp, in amounts generally employed. In a preferred embodiment relating to profiled (e.g., as by cutting or grinding) multi-v-ribbed belts, such fiber loading is preferably formed and arranged such that a substantial portion of the fibers are formed and arranged to lay in a direction generally perpendicular to the radial axis and the direction of travel of the belt and substantially parallel to the width or transverse direction of the belt.

The cured composition for utilization in at least partial contact with the load carrier cord within the composite belt structure as described in several embodiments above for FIGS. 1-3 may optionally include the features and benefits thereof described in detail in aforementioned U.S. Pat. No. 6,616,558, the contents of which have been incorporated herein by reference.

In operation, the belt is generally trained about at least one driver pulley and one driven pulley to form a belt drive or drive system, optionally in combination with an idler pulley and/or other pulleys.

In each of the cases of FIGS. 2-4 shown above, the main belt body portion 12 may be formed of any conventional and/or suitable cured elastomer composition, and may be of the same as or different from that described below in relation to the optional adhesive rubber member 18. The elastomer composition includes an organoclay additive as described generally herein and in connection with the specific examples herein.

As discussed above, in an embodiment the belts of FIGS. 2 and 3 are manufactured so that the plane of each of the organoclay masterbatch particles is substantially perpendicular to the radial axis of the elastomeric belt body and substantially parallel to the transverse and circumferential axes. In an embodiment of the belt of FIG. 4, the polymer may be applied so that the organoclay masterbatch particles are initially aligned. However, manufacturing techniques for these types of belts often require penetration of the belt compound through the tensile cord pack or into a complex mold cavity, such as a mold containing teeth or other structures, before curing. Such penetration of the uncured polymer may affect the final orientation of some of the organoclay masterbatch particles, particularly around the structures and cord. Again, the word “substantially” is used herein to remind the reader that perfect orientation of the plane of each particle of organoclay masterbatch is not possible with current manufacturing techniques. However, it is possible to manipulate the composition during manufacture so that the planes of the organoclay masterbatch are generally parallel in the composition and then to lay the composition down during the building of the belt so that the generally parallel orientation is maintained in the final belt after curing. In this way, properties of the belt can be effectively manipulated by the alignment of the particles in the final product and are improved over providing organoclay masterbatch particles that are randomly distributed in the elastomeric belt body, or have a different planar alignment, such as substantially parallel to both the circumferential axis and the radial axis, or aligned roughly parallel to a curved surface of the belt, such as the tooth surface in a synchronous belt.

As discussed in the examples below, embodiments of the belts made of aligned organoclay masterbatch belt compositions showed improvements in crack growth resistance. This is illustrated graphically in FIG. 12 in the results of the DeMattia crack growth rate test. FIG. 12 shows that the control belt exhibited a crack growth rate of 9200 inches per million cycles, while the 4 phr organoclay masterbatch embodiment in Sample 2 exhibited a crack growth rate of only 511.1 inches per million cycles and the 8 phr organoclay masterbatch embodiment in Sample 3 exhibited a crack growth rate of only 163.6 inches per million cycles. That is, Sample 2 had only 5.5% of the crack growth rate of the control belt and Sample 3 had only 1.8% of the crack growth rate of the control belt. Another way of looking at this crack growth rate data indicates that the Sample 2 belt should last about 18 times longer than the control belt and the Sample 3 belt should last about 56 times longer if we were only considering crack growth rates and it was the only factor controlling failure of the belt.

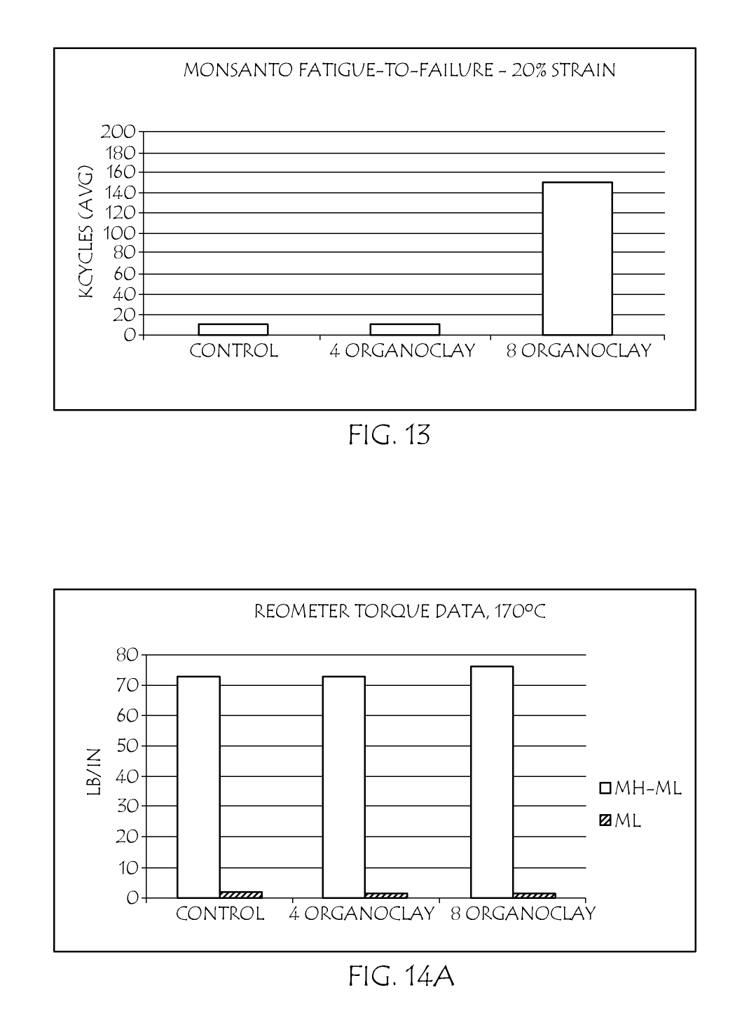

In addition, the C-Tear test of embodiments of the belts made of aligned organoclay masterbatch belt compositions showed improvements in tear resistance. This is illustrated graphically in FIG. 11. FIG. 11 shows that the control belt exhibited an inch-long tear at lower load than either organoclay masterbatch belt composition embodiment. Furthermore, at the presumed operating temperature, a better tear resistance was observed with increasing organoclay masterbatch content. Another notable result was the drastic improvement of fatigue properties shown in the Monsanto test in FIG. 13 indicating that improved fatigue properties were found in the 8 phr organoclay masterbatch belt composition embodiment.

### EXAMPLES

### Organoclay Masterbatch/Zinc Diacrylate in HNBR Belt Compositions

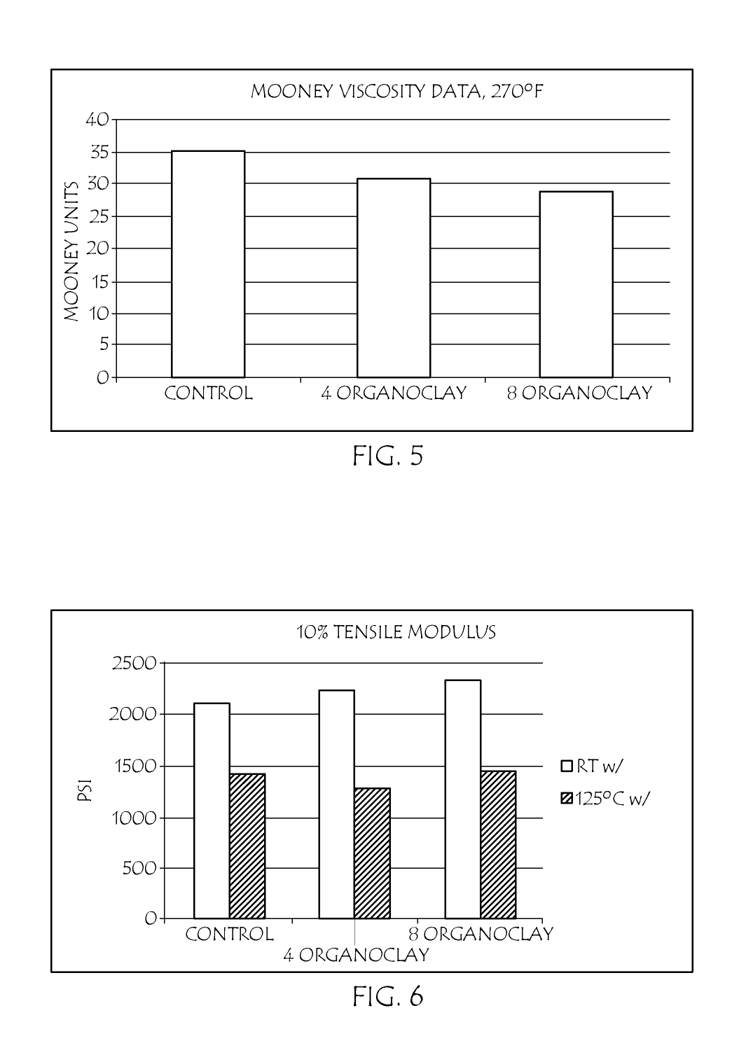

Two embodiments of organoclay masterbatch/zinc diacrylate in HNBR belt compositions were investigated in detail and are presented below with reference to Sample IDs 1, 2 and 3, TABLES 1-3 and FIGS. 5-14B.

Two embodiments of organoclay masterbatch/zinc diacrylate (ZDA) belt compositions were investigated in detail, utilizing about 3.5 and about 7 phr organoclay masterbatch, respectively. The organoclay was introduced as a masterbatch in polymer and the concentration of organoclay in the final belt composition was controlled by varying the amount of masterbatch introduced. TABLE 1 shows the recipes for the masterbatch. The combination used for this was: 100 phr a low viscosity HNBR (in this example Zetpol 2010EP), 12 phr of a maleated polybutadiene (Ricobond 2031), 88 phr organoclay (Nanomer I.44PL2 from Nanocor) and 16 phr of a vinylsilane coupling agent (Dynasylan VTEO—vinyl triethoxysilane). This masterbatch was mixed prior to being combined with the rubber that contained the ZDA.

TABLE 1
Organoclay/HNBR Masterbatch Recipe

| Material | PHR |
|---|---|
| HNBR | 100.00 |
| Maleated Polybutadiene | 12.00 |
| Organoclay | 88.00 |
| Vinylsilane Coupling Agent | 16.00 |

The final rubber compound (the rubber with the masterbatch included) for each of the samples used for the testing is provided in TABLE 2. The raw data from the testing is provided in TABLE 3.

TABLE 2
Complete Rubber Recipe

| | Sample ID | | |
|---|---|---|---|
| | 1 | | |
| | (Control) | 2 | 3 |
| Material | PHR | PHR | PHR |
| HNBR | 100 | 96.00 | 92.00 |
| ZDA | 45.00 | 45.00 | 45.00 |
| Carbon Black | 12.00 | 12.00 | 12.00 |
| Silica | 13.00 | 9.00 | 5.00 |
| Plasticizer | 5.00 | 5.00 | 5.00 |
| Anti-Degradant | 3.00 | 3.00 | 3.00 |
| ZnO | 10.00 | 10.00 | 10.00 |
| Aramid Fiber | 7.00 | 7.00 | 7.00 |
| Wax | 2.00 | 2.00 | 2.00 |
| Vinyl TriethoxySilane | 1.07 | 1.07 | 1.07 |
| Organoclay/HNBR Masterbatch of | 0.00 | 8.00 | 16.00 |
| TABLE 1 | | | |
| Organic Peroxide, 40% active powder | 9.00 | 9.00 | 9.00 |
| Triallyl isocyanurate 72% active | 4.30 | 4.30 | 4.30 |

Mixing:

The two embodiments of organoclay masterbatch belt compositions, labeled Sample 2 and 3 and a control sample, Sample 1, were mixed in a B Banbury mixer using the following procedure. First Pass: (Rpm-40/60, Ram pressure-30 psi, Water—100° F., Front Roll—90° F., Back Roll—80° F.); 0′—add all except CB and oil, 80″—add ½ CB, and oil, 170″/75° C.—adjust rpm to temp, 245″—scrape, 260″/100° C.—add ½ CB and silane, 320″/115° C.—lift, scrape, 395″/125° C.—lift, scrape, 455″—lift, scrape, 600″/155° C.—Dump. Samples ran 10′ and dumped @ 249-280° F. (probe).

Final Pass: (Rpm—30/40, Ram pressure—30 psi, Water—100° F., Front Roll—90° F., Back roll—80° F.); 0′—Add ½ MB and curatives, 45″—add ½ MB, 75″—use rpm to adjust temp, 90″—lift, scrape, 135″/80° C.—lift, scrape, 4′/107° C.—Dump. Samples ran 4′ and dumped @ 199-233° F.

Testing:

Typical rubber compound testing methods were used to evaluate the performance of the organoclay masterbatch compositions relative to the control sample. This includes Rheology (MDR, Mooney Viscosity, RPA), tensile, C-Tear, DIN abrasion, DeMattia flex (crack growth), Monsanto Fatigue-to-failure, Compression set and Shore A hardness.

Results and Discussion:

TABLE 3
Physical Property Data

| | Sample ID | | |
|---|---|---|---|
| | 1 | 2 | 3 |
| MDR, 170° C., 30 min. | | | |
| ML, lb in | 1.17 | 0.89 | 0.76 |
| MH, lb in | 74.22 | 73.68 | 76.8 |
| MH − ML, lb in | 73.05 | 72.79 | 76.04 |
| ts2, min | 0.39 | 0.41 | 0.39 |
| t10, min | 0.59 | 0.59 | 0.55 |
| t40, min | 1.81 | 1.78 | 1.68 |
| t50, min | 2.56 | 2.5 | 2.38 |
| t60, min | 3.54 | 3.45 | 3.3 |
| t90, min | 10.06 | 9.6 | 9.06 |
| t99, min | 19.1 | 17.7 | 15.87 |
| Cure Time Assigned, min@170 | 21 | 21 | 19 |
| Mooney Viscometer, 132° C., | | | |
| 15 min. | | | |
| ML | 35.18 | 30.82 | 28.97 |
| tML | 6.03 | 5.87 | 5.6 |
| MH | 70.43 | 66.07 | 64.1 |
| ML(1 + 1) | 51.15 | 47.5 | 47.98 |
| ML(1 + 2) | 41.04 | 37.19 | 35.82 |
| ML(1 + 3) | 37.56 | 33.28 | 31.43 |
| t3, min | 7.33 | 7.42 | 7.37 |
| t5, min | 7.71 | 7.79 | 7.81 |
| t18, min | 9.44 | 9.27 | 9.52 |
| t35, min | 11.67 | 11.02 | 11.36 |
| Final, min | 70.43 | 66.07 | 64.1 |
| ML(1 + 4) | 35.82 | 31.44 | 29.57 |
| RPA, 175° C. | | | |
| G*, kPa | | | |
| 2000 cpm, strain 0.09 deg | 9491 | 9627 | 10702 |
| 1500 cpm, strain 0.12 deg | 9224 | 9361 | 10428 |
| 1000 cpm, strain 0.18 deg | 8768 | 8872 | 9817 |
| 500 cpm, strain 0.36 deg | 7774 | 7828 | 8553 |
| 200 cpm, strain 0.89 deg | 6254 | 6129 | 6365 |
| 100 cpm, strain 1.78 deg | nv | nv | nv |
| G′, kPa | | | |
| 2000 cpm, strain 0.09 deg | 9480 | 9615 | 10691 |
| 1500 cpm, strain 0.12 deg | 9211 | 9347 | 10413 |
| 1000 cpm, strain 0.18 deg | 8752 | 8856 | 9798 |
| 500 cpm, strain 0.36 deg | 7755 | 7808 | 8530 |
| 200 cpm, strain 0.89 deg | 6234 | 6104 | 6330 |
| 100 cpm, strain 1.78 deg | nv | nv | nv |
| G″, kPa | | | |
| 2000 cpm, strain 0.09 deg | 452.66 | 470.64 | 494.71 |
| 1500 cpm, strain 0.12 deg | 491.6 | 511.0 | 546.8 |
| 1000 cpm, strain 0.18 deg | 525.9 | 537.7 | 596.2 |
| 500 cpm, strain 0.36 deg | 540.1 | 566.5 | 638.9 |
| 200 cpm, strain 0.89 deg | 493.5 | 548.3 | 667.4 |
| 100 cpm, strain 1.78 deg | nv | nv | nv |
| J′, 1/MPa | | | |
| 2000 cpm, strain 0.09 deg | 0.005 | 0.005 | 0.004 |
| 1500 cpm, strain 0.12 deg | 0.006 | 0.006 | 0.005 |
| 1000 cpm, strain 0.18 deg | 0.007 | 0.007 | 0.006 |
| 500 cpm, strain 0.36 deg | 0.009 | 0.009 | 0.009 |
| 200 cpm, strain 0.89 deg | 0.013 | 0.015 | 0.016 |
| 100 cpm, strain 1.78 deg | nv | nv | nv |
| tan delta | | | |
| 2000 cpm, strain 0.09 deg | 0.048 | 0.049 | 0.046 |
| 1500 cpm, strain 0.12 deg | 0.053 | 0.055 | 0.053 |
| 1000 cpm, strain 0.18 deg | 0.060 | 0.061 | 0.061 |
| 500 cpm, strain 0.36 deg | 0.070 | 0.073 | 0.075 |
| 200 cpm, strain 0.89 deg | 0.08 | 0.09 | 0.11 |
| 100 cpm, strain 1.78 deg | nv | nv | nv |
| C-Tear, RT, Init., w/g, | | | |
| 6″/min crosshead speed | | | |
| Load at Max.Load (lbs) | 37.61 | 42.72 | 39.06 |
| Load/Thick at Max.Load (lbs/in) | 383.8 | 440.4 | 434.0 |
| Maximum Displacement (in) | 0.48 | 0.60 | 0.57 |
| C-Tear, 125° C., Init., w/g, | | | |
| 6″/min crosshead speed | | | |
| Load at Max.Load (lb) | 14.7 | 19.6 | 22.1 |
| Load/Thick at Max.Load (lb/in) | 154.8 | 212.6 | 239.7 |
| Tensile, Init., RT, w/g, | | | |
| 6″/min crosshead speed | | | |
| Maximum Stress (psi) | 4226 | 4391 | 3962 |
| % Strain at Break (%) | 199.0 | 192.3 | 196.7 |
| Stress at 5% Strain (psi) | 906 | 1481 | 1771 |
| Stress at 10% Strain (psi) | 2122 | 2254 | 2344 |
| Stress at 20% Strain (psi) | 2079 | 2223 | 2316 |
| Stress at 25% Strain (psi) | 2107 | 2225 | 2250 |
| Stress at 50% Strain (psi) | 2299 | 2472 | 2367 |
| Stress at 100% Strain (psi) | 4098 | 4432 | 4016 |
| Tensile, Init., 125° C., w/g, | | | |
| 6″/min crosshead speed | | | |
| Maximum Stress (psi) | 1473 | 1503 | 1759 |
| % Strain at Break (%) | 56 | 83 | 104 |
| Stress at 5% Strain (psi) | 877 | 1138 | 1202 |
| Stress at 10% Strain (psi) | 1436 | 1303 | 1457 |
| Stress at 20% Strain (psi) | 1274 | 1237 | 1365 |
| Stress at 25% Strain (psi) | 1269 | 1216 | 1366 |
| Stress at 50% Strain (psi) | 1259 | 1234 | 1325 |
| Stress at 100% Strain (psi) | | | 1328 |
| Shore A Hardness | 91 | 93 | 94 |
| DeMattia Flex, 300 cpm, | | | |
| 0.5 stroke, 125° C., w/g | | | |
| Mean in/Megacycle | 9200 | 511.1 | 163.6 |
| Mean kilocycle/inch | 0 | 2.5 | 8 |
| Monsanto Fatigue-to-Failure | | | |
| (w/g) - 20% strain | | | |
| avg. count (kcycles) | 10 | 10 | 150 |
| permanent set (%) | 4.1 | 4.1 | 4.1 |

FIG. 5 illustrates the Mooney viscosity data. Mooney viscosity (“MV” indicated by ML in TABLE 3) and scorch time (t5) were tested at 132° C(270° F.) for 30 minutes according to ASTM D1646. The Mooney viscosity data are of interest for these compounds because of a current manufacturing process for synchronous belts. In this process, the preformed jacket is applied to the building drum and then cord is wound on the drum. The rubber compound is applied on the outside and must squeeze or flow between the cords to fill the belt teeth. This requires that the viscosity not be too high or tooth formation will be incomplete. In this series of compounds, we have already used a low viscosity hydrogenated nitrile butadiene rubber (HNBR) polymer (Zetpol 2010EP) to help achieve this. In introducing additional materials into the compound, it is preferable not to drive the viscosity higher so as to avoid this issue. As seen in TABLE 3, the organoclay masterbatch compounds show a notable decrease in viscosity, decreasing with increased organoclay masterbatch content. This is a very good result from a processing point of view in that the organoclay masterbatch compounds will be easier to manipulate during the manufacturing process, for example by improving the filling of teeth or other features in a mold.

FIG. 6 illustrates the 10% tensile modulus data. Tensile modulus is reported as stress at given elongation in accordance with ASTM D1566 and D412. Along with this decrease in viscosity, it is important to maintain the modulus of the compound. The 10% modulus shows an increase in modulus similar to that noted for the Rheometer torque for the organoclay masterbatch compounds. This is an intriguing combination of lower uncured stiffness with increased cured stiffness.

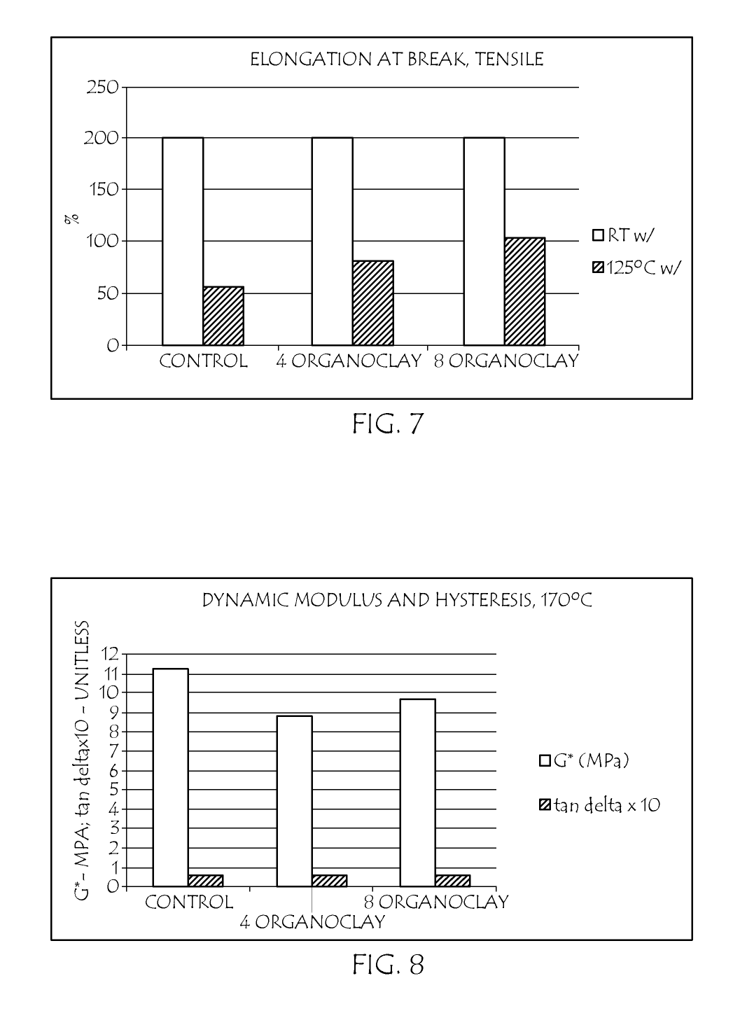

FIG. 7 illustrates the elongation at break data. The elongation at break data (FIG. 5) shows most of these compounds to have elongation at break similar to the control compound. This is an excellent result when coupled with the increase in modulus.

FIG. 8 illustrates the dynamic modulus data. The dynamic modulus data were measured with an RPA tester according to the procedure of ASTM D6601 at a temperature of 175° C. The dynamic modulus data for these compounds reflects the tensile modulus previous shown. The organoclay masterbatch compounds show an increase in modulus based on level used.

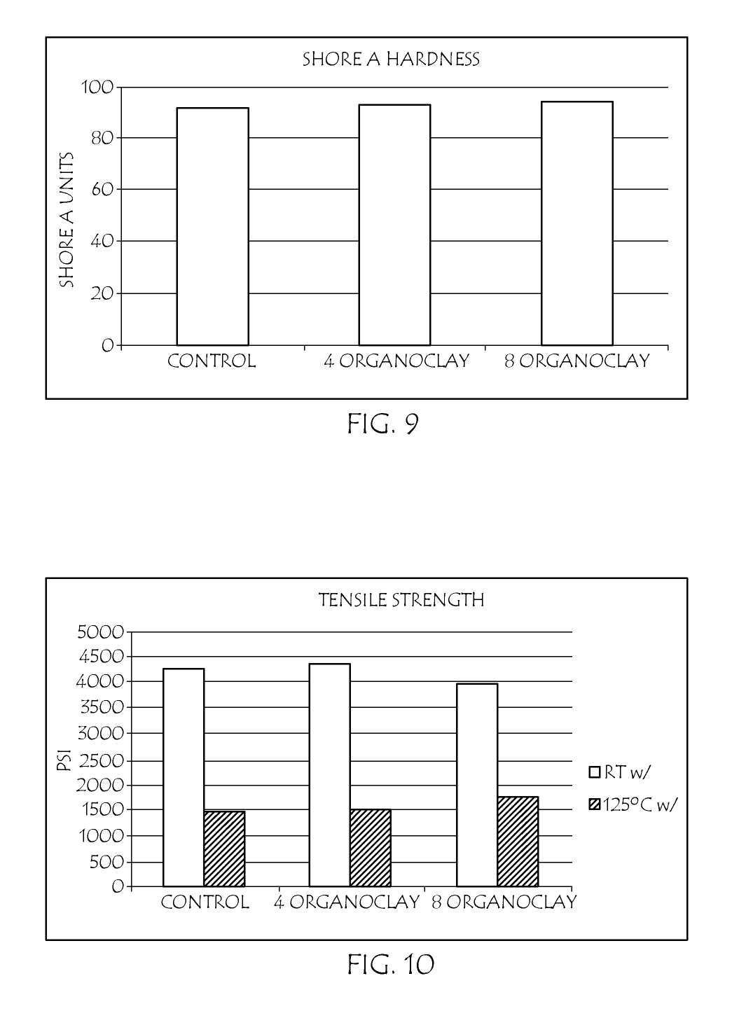

FIG. 9 illustrates the hardness data on the Shore A scale. Hardness was tested according to ASTM D2240. The hardness data for these compounds show very little difference, with the organoclay masterbatch showing only a modest increase.

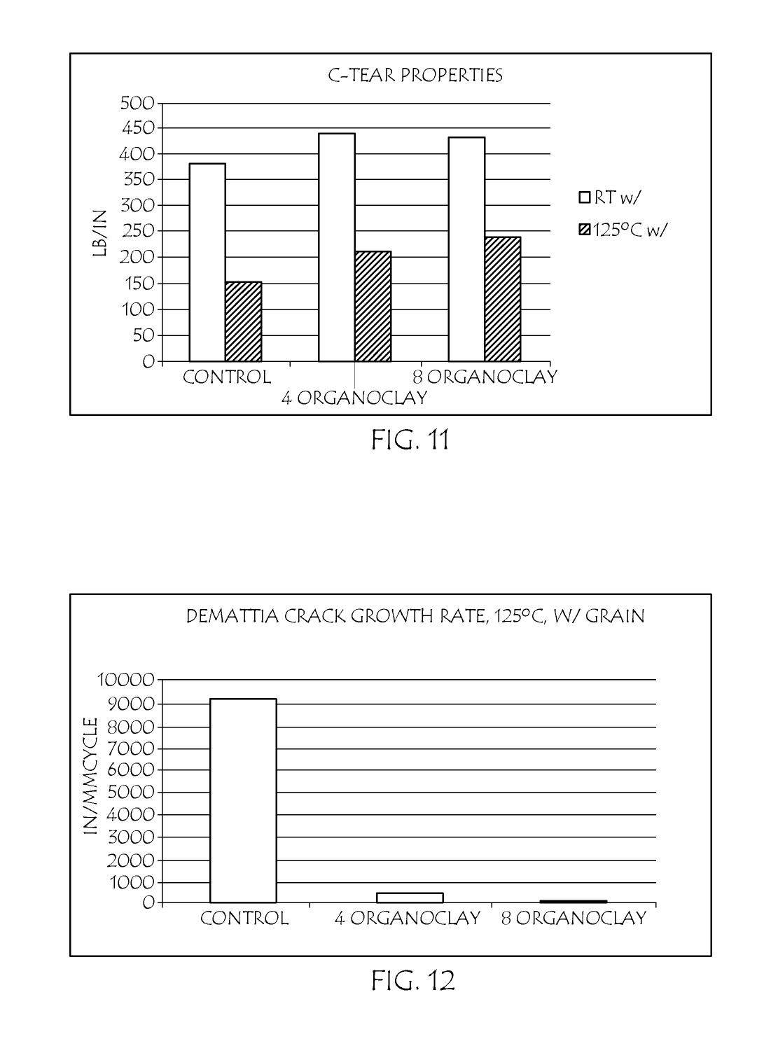

FIG. 10 illustrates the tensile strength data. Tensile properties shown in TABLE 3 were tested according to ASTM D412, die C. The tensile strength of these compounds is a bit variable. The organoclay masterbatch compounds were both modestly above and below the control.

FIG. 11 illustrates the results of the tear properties test. Tear strength was tested with die C according to ASTM D624. The tear properties of these compounds were all better or equivalent to the control compound. The two organoclay masterbatch belt compounds showed very nice values in spite of the increased modulus of the compound which is also unexpected.

FIG. 12 illustrates the results of the DeMattia crack growth rate test. DeMattia crack growth was determined in accordance with ASTM D813. A pierced DeMattia test was performed under the conditions identified in the Figure. Data in TABLE 3 are reported as inches per Megacycle (million cycles) and kilocycles (thousand cycles per inch of crack). The DeMattia crack growth rates of these compounds are very interesting. The compounds of the two organoclay masterbatch/ZDA belt compositions show a notable improvement in crack growth resistance. The improvement for the organoclay masterbatch compounds is very striking, especially in combination with the other properties of the organoclay masterbatch/ZDA belts.

Tests were further performed (data not provided) in which the orientation of the aligned particles within the plane orthogonal to the radial axis was investigated. These tests showed no significant change in DeMattia crack growth results. Without being held to a particular theory, this possibly indicates that the planar particles do not exhibit substantial differences between average particle lengths and widths and thus do not, in effect, show the effects that one would expect of a fiber.

FIG. 13 illustrates the results of the fatigue properties testing. The fatigue properties of these compounds show that an improvement in fatigue is possible at slightly higher levels of the organoclay masterbatch.

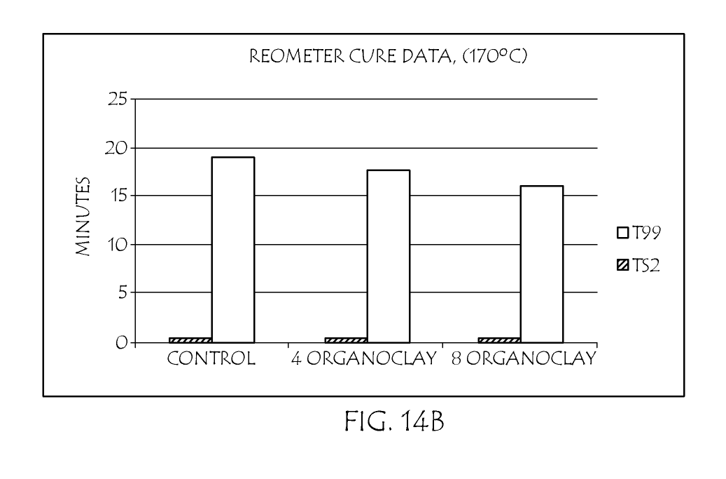

FIGS. 14A and 14B illustrate the Rheometer data for the two organoclay masterbatch embodiments and the control compound. Cure characteristics were tested on the moving die Rheometer (MDR) at 170° C. for 30 minutes according to ASTM D5289. In FIG. 14A, the Rheometer torque data for this series shows that increased organoclay masterbatch in the compounds appears to result in increased torque.

FIG. 14B illustrates cure time data. The scorch time, indicated by Ts2 showed no effect, while the organoclay masterbatch reduced the cure time (t99) of the compound. The Rheometer cure time data in TABLE 3 also shows that the organoclay masterbatch reduces the cure time of these compounds.

Overall, it would appear that the aligned organoclay masterbatch compounds offer improvements in processing and properties while maintaining or improving tear, fatigue and crack growth resistance. The higher level of organoclay masterbatch used in this study would be an excellent candidate for a elastomeric compound because it provides: a) lower Mooney viscosity (resulting in greater ease of processing), b) higher stiffness (both tensile and dynamic) c) improved tear resistance, d) lower crack growth rate and e) nearly equivalent fatigue resistance in spite of the increased stiffness. This surprising result indicates that using organoclay masterbatch in HNBR synchronous belts may be viable, as the decrease in viscosity would enhance the ability to build belts by improving tooth fill during manufacture.

### EXAMPLES

### Organoclay Masterbatch/Zinc Dimethacrylate in EPDM Belt Compositions

In performing the above work in organoclay masterbatch/ZDA in HNBR belt compositions, the investigator identified the effects of an interaction between the organoclay masterbatch and the MSA at work in the belt composition. In order to further investigate whether this interaction was also evident in other belt composition systems, further experiments were done using organoclay masterbatch/zinc dimethacrylate in EPDM belt composition. A design study was utilized to investigate this interaction by looking at a number of different samples having varied ZDMA and organoclay masterbatch concentrations. These experiments are presented below.

These examples indicate that organoclay masterbatch is a beneficial additive to EPDM belt compositions and that the properties of an organoclay masterbatch belt composition can be further manipulated by changing either or both of the MSA or the organoclay masterbatch concentrations in the final belt composition. Without being bound to any particular theory, it is believed that the MSA may provide additional compatibilization to the organoclay beyond that provided by the maleated polymer and the reactive silane. The MSA may be acting to further separate the particles into thinner platelets, and/or may provide beneficial dispersion properties to the organoclay masterbatch in the final belt composition, leading to the surprising combination of properties shown in the finished products.

Eleven embodiments of organoclay masterbatch/ZDMA belt compositions were investigated in detail, utilizing organoclay masterbatch ranging from 0.34 to 11.66 phr and ZDMA ranging from 6.89 to 17.5 phr, respectively. The organoclay was compatibilized in a masterbatch in EPDM polymer. The final concentration of organoclay masterbatch in a particular belt composition was controlled by varying the amount of masterbatch in the final belt composition. The ZDMA was introduced in the polymer and its concentration was controlled directly at the polymer mixing stage.

TABLE 4 shows the recipe for the masterbatch created containing organoclay in EPDM. The combination used for this was: 100 phr of a low viscosity EPDM (in this example Buna EP 2470 LM P, now known as Keltan 2470L provided by Lanxess), 12 phr of a maleated polybutadiene (Ricobond 2031 provided by Cray Valley), 88phr organoclay (Nanomer I.44PL2 from Nanocor) and 8 phr of a vinylsilane coupling agent (Dynasylan VTEO provided by Evonik). This masterbatch was mixed prior to being combined with the rubber that contained the ZDMA.

TABLE 4
Organoclay/EPDM Masterbatch Recipe

| Material | PHR |
|---|---|
| EPDM | 100 |
| Maleated Polybutadiene | 12 |
| Organoclay | 88 |
| Vinylsilane Coupling Agent | 8 |

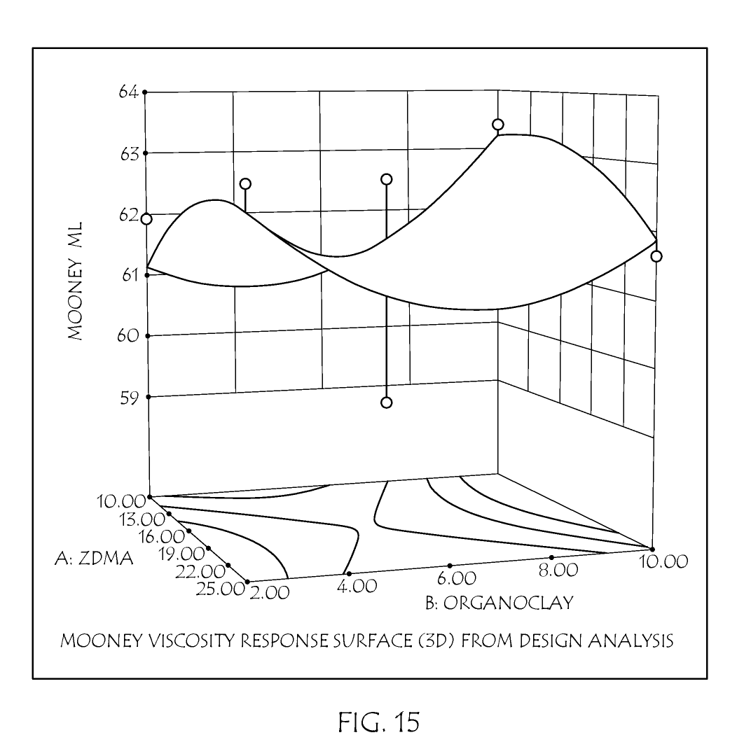

The general final rubber compound (the rubber with the masterbatch included) for each of the samples used for the testing is provided in TABLE 5 while the specific variations of each embodiment are provided in TABLE 6 and selected results of the analysis are presented graphically in FIGS. 15-18.

TABLE 5
General Rubber Recipe

| Material | PHR |
|---|---|
| EPDM | 100 |
| ZDMA | Variable |
| Carbon Black (CB330) | 61.9 |
| Anti-oxidant | 0.9 |
| ZnO | 2.86 |
| Nylon flock | 4.76 |
| Zinc Stearate | 5.71 |
| Sunpar 2280 | 11 |
| Organoclay/EPDM | Variable |
| Masterbatch of TABLE 4 | |
| Scorch retarder | 0.29 |
| Organic Peroxide, 40% active | 4.88 |
| powder | |

Mixing:

The following mixing procedures were used for the B Banbury mixer. Organoclay masterbatch-single-pass mix: (Rpm—75, Ram pressure—30 psi, Water—On, Front Roll—145° F., Back Roll—135° F.); 0′—Added ½ poly, fillers, chemicals and ½ poly, 1′—Scrape, 2′ (and every 2′)—Scrape, 10′—Dump. All variables ran 10′ and dumped @ 194-228F (probe 258F.).

First Pass: (Rpm—100/75, Ram pressure 30 psi, Water—80° F., Front Roll—80° F., Back Roll—70° F.); 0′—Add polymer, MB, black, Anti-oxidant, Retarder 8018, scorch retarder, ZnStearate, 1′—add fiber, 190° F.—lift, scrape, 230° F.—add oil, 260° F.—lift, scrape, 275° F.—Dump.

Samples ran 7′30″-10′ and dumped @ 297-327° F. (probe).

Final Pass: (Rpm—55/45, Ram pressure—30 psi, Water—80° F., Front Roll—80° F., Back Roll—70° F.); 0′—Added all (sandwich curatives), 30″—scrape, 1′—scrape, 250° F.—Dump. Samples ran 3′15″-4′ and dumped @ 217-236° F. (probe).

Testing:

The testing conducted here would be considered typical testing for rubber compounds. This includes Rheology (MDR, Mooney, RPA), tensile, C-Tear, DeMattia crack growth, Monsanto Fatigue-to-failure, Compression set and Shore A hardness.

Results and Discussion:

As mentioned above, to evaluate the interaction between organoclay masterbatch and ZDMA, a central composite design was devised. The ranges for each material were as follows: organoclay masterbatch—low value—0.34 phr, high value—11.66 phr; ZDMA—low value—6.89 phr, high value—28.11 phr. The design series is shown in TABLE 6. The compounds were all mixed using the same procedure and the resulting compounds were evaluated using the tests described in the Experimental section. The results of these tests were used in an analysis of the data using Design Expert 8 software. Standard analysis was conducted to determine the nature of the interaction for each property (the model type that fits the data) and a plot of the relationship. These will be discussed below.

TABLE 6
Central Composite Design Samples

| Material | 2 | 3 | 4 | 5 | 6 | 7 | 8 | 9 | 10 | 11 | 12 |
|---|---|---|---|---|---|---|---|---|---|---|---|
| ZDMA (phr) | 17.5 | 17.5 | 10 | 10 | 25 | 17.5 | 17.5 | 28.11 | 17.5 | 6.89 | 25 |
| Organoclay (phr) | 11.66 | 0.34 | 10 | 2 | 2 | 6 | 6 | 6 | 6 | 6 | 10 |

FIG. 15 illustrates the Mooney viscosity response surface (3D) from design analysis for organoclay masterbatch/ZDMA in EPDM samples. The relationship found was a quadratic model, indicating an interaction between the two materials. When the plot of the response surface was examined, there was an indication that the response of the viscosity was different at low and high levels of ZDMA. At low ZDMA levels, the minimum viscosity was found at about 4.3 phr, with a higher viscosity at lower or higher organoclay masterbatch levels. When high levels of ZDMA were examined, the minimum point rose to almost 6.5 phr. It was also noted that the difference in viscosity caused by adding organoclay masterbatch at the extremes of the ZDMA range changed. At low levels of ZDMA, the viscosity dropped slightly as organoclay masterbatch was added but quickly rose. At high ZDMA levels, the viscosity dropped noticeably to a minimum and then rose to a value lower than at low levels. These responses were interesting and may explain other results discussed below.

Based on a comparison of these results with those shown in FIG. 5, it is possible that the level of clay where the viscosity minimum in the organoclay masterbatch/ZDA embodiments occurs at a higher organoclay masterbatch level than tested. It also appears that such a viscosity minimum in the organoclay masterbatch/ZDA embodiments occurs at a higher organoclay masterbatch level than for the ZDMA/EPDM compounds. However, the overall trend appears to be consistent with both systems. These results also indicate a clear interaction between the organoclay and the zinc dimethacrylate.

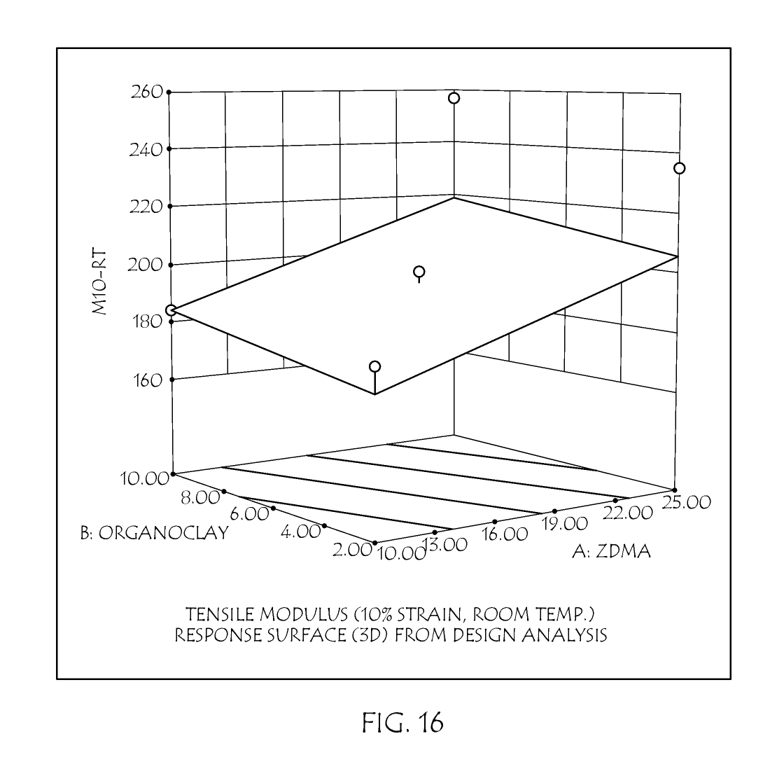

FIG. 16 illustrates the Tensile Modulus (10% strain, room temp.) response surface (3D) from Design analysis for organoclay masterbatch/ZDMA in EPDM samples. The response surface for tensile modulus at 10% strain was observed to have a linear relationship, indicating that there was not much interaction between the two materials for this property. Increasing either material resulted in an increase in modulus. The ZDMA appeared to have larger effect on the results although this plot is deceiving because the scale for each material is not the same. If adjusted for this difference, the amount of modulus increase per phr is relatively close, as indicated in the equation (Eq. 1) for estimating the value.

M10−RT=+145.68438+2.27711*ZDMA+1.60951*Organoclay (Eq1)

Based on a comparison of these results with those shown in FIG. 6, both the organoclay masterbatch/ZDA and organoclay masterbatch/ZDMA embodiments illustrate that an increase in the organoclay additive shows an increase in modulus. This consistent increase in modulus, along with the decrease in viscosity, is particularly an attractive combination for synchronous belt compounds.

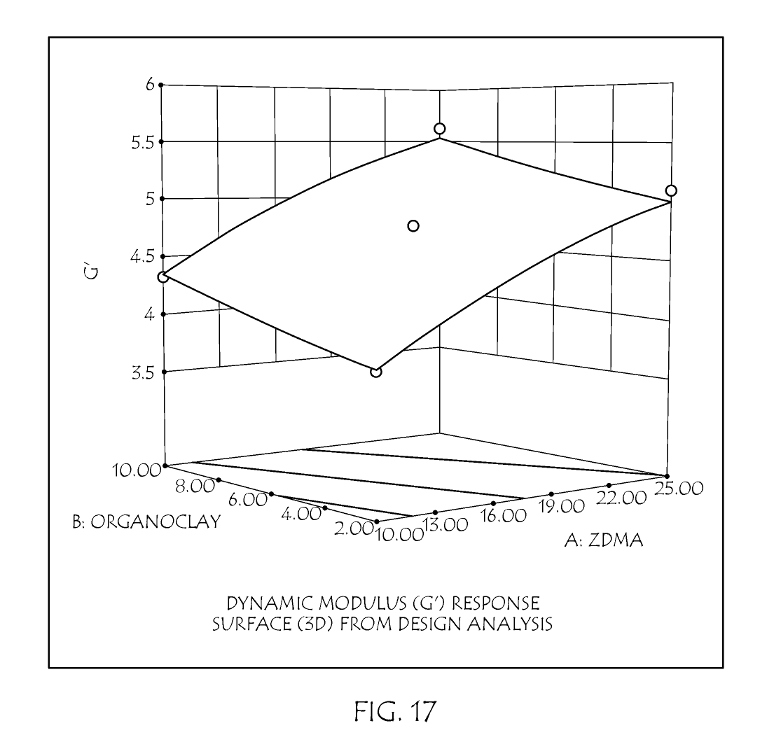

FIG. 17 illustrates the Dynamic Modulus response surface (3D) from design analysis for organoclay masterbatch/ZDMA in EPDM samples. The analysis of the dynamic modulus (determined by RPA at 175° C.) shows the relationship was determined to be a quadratic, indicating interaction. However, the level of interaction is not as large as with viscosity based on the amount of curvature observed. For this property, the ZDMA appears to have a large effect on the results and the difference between ZDMA and organoclay masterbatch is larger than with tensile modulus. Equation 2 shows the difference in the ZDMA and organoclay masterbatch terms.

$${G}^{′} = + 2.39823 + 0.15402 * ZDMA + 0.041916 * Organoclay - 8.33333 E - 006 * ZDMA * Organoclay - 2.14926 E - 003 * {ZDMA}^{2} + 2.13151 E - 003 * {Organoclay}^{2} \qquad ( Eq . 2 )$$

The dynamic modulus was shown in the organoclay masterbatch/ZDMA design study to have the same trend in dynamic modulus increase with organoclay as the tensile modulus as found in organoclay masterbatch/ZDA embodiments shown in FIG. 8.

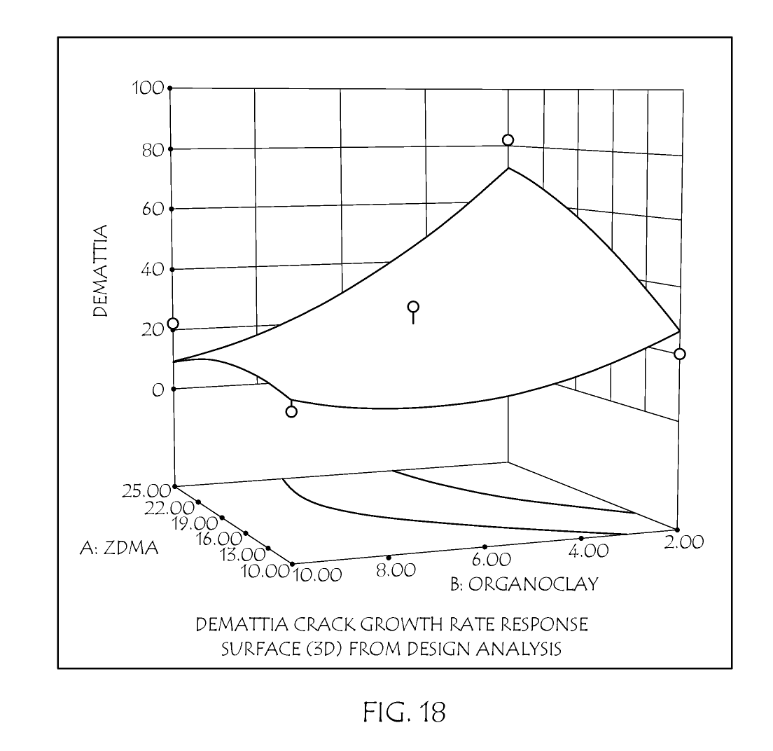

FIG. 18 illustrates the DeMattia crack growth rate response surface (3D) from design analysis for organoclay masterbatch/ZDMA in EPDM samples. The response surface shows another quadratic relationship between the organoclay masterbatch and the ZDMA. The reduction in crack growth rate from addition of organoclay masterbatch is much higher at higher ZDMA levels than at lower levels. This is very obviously an interaction between the two materials. The equation for this relationship (Eq. 3) is very revealing of the effect of each material on the crack growth rate (in/Megacycles).

$$DeMattia ( cg rate ) = - 17.79872 + 7.05272 * ZDMA - 5.22127 * Organoclay - 0.40833 * ZDMA * Organoclay - 0.092704 * {ZDMA}^{2} + 0.62878 * {Organoclay}^{2} \qquad ( Eq . 3 )$$

Based on a comparison of these results with those shown in FIG. 12, both the organoclay masterbatch/ZDA and organoclay masterbatch/ZDMA embodiments illustrate that an increase in the organoclay additive shows a decrease in crack growth rate at higher levels of ZDMA. However, the relationship illustrates that, for a given MSA, a minimum growth rate may exist. For example, FIG. 18 indicates that for a ZDMA level of 10 phr, a minimum DeMattia crack growth rate may occur at around 7 phr organoclay masterbatch. The results show that increased organoclay masterbatch will reduce the crack growth rate but that very high organoclay masterbatch levels may eventually be detrimental.

An analysis of tear properties showed almost no relationship or the effect of each material was almost undetectable. The values were rather uniform across the design variables and indicated a “mean value” model. The C-Tear properties of the organoclay masterbatch/ZDA in HNBR embodiments also showed an increase in tear resistance (FIG. 11) in the organoclay-containing compounds but the level also did not appear to increase with increasing organoclay masterbatch content.

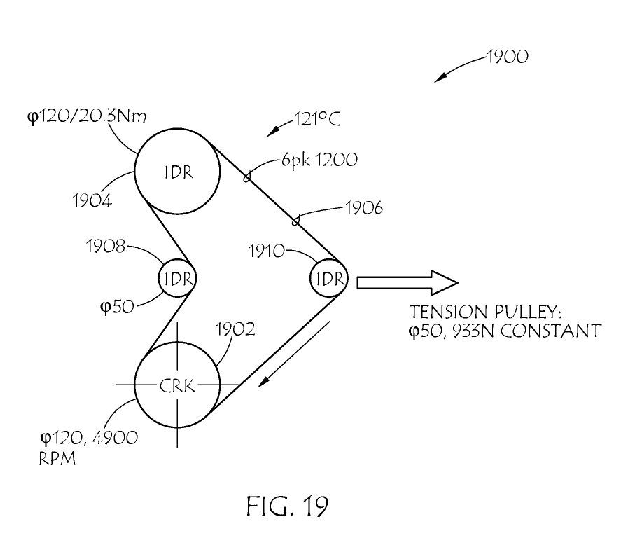

The use of the organoclay in an actual belt test has also been demonstrated. Two different EPDM rubber belt compounds were prepared with and without 4 phr organoclay added according to an embodiment of the invention. The compounds were used as the main belt body composition for multi-v-ribbed belts (see FIG. 2). The belts were all 6PK1200 constructions with 6 ribs and 1200 mm in length. FIG. 19 is a diagram of the Durability test. The drive includes a 120-mm diameter driver pulley 1902 running at 4900 rpm, a 120-mm driven pulley 1904 with a 20.3 Nm torque load on the belt 1906, and two idlers of 50-mm diameter 1908, 1910. One idler 1908 is centered between the driver and driven pulley and contacts the belt backside surface. The other idler 1910 is inside the belt and displaced from the center line of the other three pulleys, thus tensioning the belt at 933 N constant tension.

This test is run until the belt fails, typically with rib cracks. The criterion here is 8 rib cracks and the belt is considered to have failed. Also, if the belt breaks or disintegrates, that is also a failure (but less likely). The Durability test results showed that the organoclay can significantly improve belt durability, presumably by inhibiting crack initiation or crack growth. In the two comparative experiments with and without organoclay, the belt lifetime was increased from 66 to 173 hours for one comparison, and from 87 to 125 hours for the second comparison, both attributable to the addition of organoclay.

Subsequent testing was performed to identify the effect of variations in concentrations of the ingredients other than organoclay in the organoclay masterbatch. In this testing, the following masterbatches were created in the same manner as described above.

TABLE 7
Masterbatch Recipes

| | Masterbatch ID | | | |
|---|---|---|---|---|
| | MB1 | MB2 | MB3 | MB4 |
| EPDM | 50 | 50 | 50 | 50 |
| Maleated Polybutadiene (phr) | 6 | 6 | 0 | 6 |
| Organoclay (phr) | 44 | 44 | 44 | 44 |
| ZDMA (phr) | 0 | 5 | 5 | 5 |
| Vinylsilane Coupling Agent (phr) | 8 | 8 | 8 | 0 |

From analysis of these embodiments, it would appear that as long as at least two of the ingredients (ZDMA, maleated polymer, silane) are present, there are no major changes in the results of the compounding. This effect was seen across all the properties.

Further testing also was performed to identify the effect of higher concentrations of organoclay on belt performance properties. In this testing, a masterbatch, MB1 (from TABLE 7), was added in different amounts in a mixing operation 104 to achieve final concentrations of the organoclay ranging from 1 phr to 32 phr. The general recipe is provided below in TABLE 8 and the resulting data are provided in TABLE 9.

TABLE 8
General Rubber Recipe

| Material | PHR |
|---|---|
| EPDM | 100 |
| Carbon Black | 61.9 |
| ZDMA | 15 |
| Anti-Oxidant | 0.9 |
| ZnO | 2.86 |
| Nylon flock | 4.76 |
| Zinc Stearate | 5.71 |
| Sunpar 2280 | 11 |
| MB1 of TABLE 7 | Variable |
| Scorch retarder | 0.29 |
| Organic Peroxide, 40% active powder | 4.88 |

TABLE 9
Physical Property Data

| | Sample ID | | | | | | | |
|---|---|---|---|---|---|---|---|---|
| | 1 | 2 | 3 | 4 | 5 | 6 | 7 | 8 |
| Description | control | 1 phr | 2 phr | 4 phr | 8 phr | 16 phr | 24 phr | 32 phr |
| MB1 of TABLE 7 | 0 | 2.4 | 4.91 | 9.82 | 19.64 | 39.27 | 58.91 | 78.55 |
| Physical Property Data | | | | | | | | |
| MDR, 170° C., 30 min. | | | | | | | | |
| ML, lb in | 2 | 1.9 | 1.87 | 1.76 | 2.11 | 2.47 | 2.48 | 2.53 |
| MH, lb in | 35.09 | 34.88 | 35.39 | 35.78 | 38.1 | 42.68 | 46.6 | 53.39 |
| MH − ML, lb in | 33.09 | 32.98 | 33.52 | 34.02 | 35.99 | 40.21 | 44.12 | 50.86 |
| ts2, min | 0.76 | 0.78 | 0.72 | 0.69 | 0.66 | 0.69 | 0.68 | 0.68 |
| T10, min | 0.83 | 0.85 | 0.79 | 0.77 | 0.75 | 0.8 | 0.81 | 0.83 |
| T40, min | 1.92 | 1.97 | 1.86 | 1.79 | 1.78 | 1.83 | 1.78 | 1.8 |
| T50, min | 2.55 | 2.62 | 2.47 | 2.41 | 2.4 | 2.42 | 2.32 | 2.33 |
| T60, min | 3.38 | 3.48 | 3.29 | 3.23 | 3.22 | 3.2 | 3.03 | 3.02 |
| T90, min | 9.26 | 9.42 | 9.02 | 9 | 8.96 | 8.59 | 7.89 | 7.72 |
| T99, min | 17.28 | 16.59 | 17.69 | 17.41 | 16.16 | 15.29 | 14.51 | 13.25 |
| Cure Time Assigned, min@170 | 20 | 20 | 20 | 20 | 20 | 18 | 18 | 18 |
| Mooney, 132° C., 15 min. | | | | | | | | |
| ML | 59.38 | 58.53 | 57.53 | 58.98 | 63 | 66.57 | 62.88 | 62.09 |
| tML | 7.83 | 7 | 6.63 | 6.52 | 7.68 | 8 | 5.98 | 7.02 |
| MH | 84.9 | 84.35 | 80.58 | 84.53 | 84.65 | 102.02 | 98.19 | 97.47 |
| ML(1 + 1) | 73.59 | 69.87 | 66.99 | 71.25 | 75.14 | 78.8 | 69.34 | 69.49 |
| ML(1 + 2) | 65.84 | 63.9 | 61.73 | 64.53 | 68.61 | 71.84 | 65.97 | 64.89 |
| ML(1 + 3) | 62.44 | 61.07 | 59.4 | 61.5 | 65.6 | 68.76 | 64.02 | 63 |
| t3, min | 14.47 | 14.28 | 13.81 | 14.97 | 18.21 | 17.87 | 17.5 | 17.25 |
| t5, min | 17.58 | 17.21 | 17.65 | 18.1 | 21.45 | 20.98 | 20.43 | 20.23 |
| t18, min | 27.85 | 27.73 | 28.73 | 28.35 | 29.97 | 28.05 | 26.22 | 25.44 |
| t35, min | | | | | | 30.06 | 27.95 | 27.09 |
| Final, min | 84.86 | 84.29 | 80.49 | 84.48 | 84.65 | 102.02 | 98.19 | 97.47 |
| ML(1 + 4) | 60.88 | 59.78 | 58.33 | 59.9 | 63.93 | 67.22 | 63.14 | 62.36 |
| RPA, 175° C. | | | | | | | | |
| G*, kPa | | | | | | | | |
| 2000 cpm, strain 0.09 deg | 4665 | 4685 | 4940 | 5258 | 6061 | 7945 | 10008 | 12833 |
| 1500 cpm, strain 0.12 deg | 4389 | 4411 | 4643 | 4929 | 5626 | 7314 | 8969 | 11500 |
| 1000 cpm, strain 0.18 deg | 4039 | 4046 | 4245 | 4472 | 5059 | 6423 | 7803 | 9812 |
| 500 cpm, strain 0.36 deg | 3543 | 3555 | 3697 | 3857 | 4256 | 5139 | 6001 | 7293 |
| 200 cpm, strain 0.89 deg | 3056 | 3053 | 3139 | 3202 | 3366 | 3659 | 3984 | 4549 |
| 100 cpm, strain 1.78 deg | 2685 | 2668 | 2729 | 2632 | 2529 | 2505 | 2693 | 2865 |
| G′, kPa | | | | | | | | |
| 2000 cpm, strain 0.09 deg | 4653 | 4673 | 4927 | 5243 | 6043 | 7917 | 9968 | 12791 |
| 1500 cpm, strain 0.12 deg | 4375 | 4397 | 4628 | 4911 | 5603 | 7280 | 8921 | 11447 |
| 1000 cpm, strain 0.18 deg | 4025 | 4032 | 4231 | 4455 | 5037 | 6389 | 7754 | 9750 |
| 1000 cpm, Mpa | 4.025 | 4.032 | 4.231 | 4.455 | 5.037 | 6.389 | 7.754 | 9.750 |
| 500 cpm, strain 0.36 deg | 3532 | 3544 | 3685 | 3843 | 4238 | 5108 | 5952 | 7227 |
| 200 cpm, strain 0.89 deg | 3050 | 3046 | 3132 | 3193 | 3352 | 3630 | 3940 | 4489 |
| 100 cpm, strain 1.78 deg | 2680 | 2663 | 2724 | 2623 | 2510 | 2469 | 2649 | 2807 |
| G″, kPa | | | | | | | | |
| 2000 cpm, strain 0.09 deg | 327.08 | 330.52 | 349 | 394.99 | 475.79 | 669.21 | 887.98 | 1037.5 |
| 1500 cpm, strain 0.12 deg | 349.7 | 352.6 | 369.7 | 414.7 | 501.5 | 709.4 | 925.4 | 1109.0 |
| 1000 cpm, strain 0.18 deg | 329.1 | 331.2 | 351.3 | 388.5 | 471.6 | 660.8 | 879.2 | 1104.6 |
| 500 cpm, strain 0.36 deg | 274.9 | 278.7 | 297.1 | 328.0 | 395.0 | 567.5 | 758.6 | 981.8 |
| 200 cpm, strain 0.89 deg | 199.2 | 205.2 | 214.5 | 241.0 | 306.7 | 457.8 | 588.8 | 733.7 |
| 100 cpm, strain 1.78 deg | 155.3 | 164.0 | 172.0 | 220.2 | 307.8 | 425.5 | 480.8 | 575.0 |
| J′, 1/Mpa | | | | | | | | |
| 2000 cpm, strain 0.09 deg | 0.015 | 0.015 | 0.014 | 0.014 | 0.013 | 0.011 | 0.009 | 0.006 |
| 1500 cpm, strain 0.12 deg | 0.018 | 0.018 | 0.017 | 0.017 | 0.016 | 0.013 | 0.012 | 0.008 |
| 1000 cpm, strain 0.18 deg | 0.020 | 0.020 | 0.019 | 0.019 | 0.018 | 0.016 | 0.014 | 0.011 |
| 500 cpm, strain 0.36 deg | 0.022 | 0.022 | 0.022 | 0.022 | 0.022 | 0.021 | 0.021 | 0.018 |
| 200 cpm, strain 0.89 deg | 0.021 | 0.022 | 0.022 | 0.024 | 0.027 | 0.034 | 0.037 | 0.035 |
| 100 cpm, strain 1.78 deg | 0.022 | 0.023 | 0.023 | 0.032 | 0.048 | 0.068 | 0.066 | 0.070 |
| tan delta | | | | | | | | |
| 2000 cpm, strain 0.09 deg | 0.070 | 0.071 | 0.071 | 0.075 | 0.079 | 0.085 | 0.089 | 0.081 |
| 1500 cpm, strain 0.12 deg | 0.080 | 0.080 | 0.080 | 0.084 | 0.089 | 0.097 | 0.104 | 0.097 |
| 1000 cpm, strain 0.18 deg | 0.082 | 0.082 | 0.083 | 0.087 | 0.094 | 0.103 | 0.113 | 0.113 |
| 500 cpm, strain 0.36 deg | 0.078 | 0.079 | 0.081 | 0.085 | 0.093 | 0.111 | 0.127 | 0.136 |
| 200 cpm, strain 0.89 deg | 0.07 | 0.07 | 0.07 | 0.08 | 0.09 | 0.13 | 0.15 | 0.16 |
| 100 cpm, strain 1.78 deg | 0.058 | 0.062 | 0.063 | 0.084 | 0.123 | 0.172 | 0.181 | 0.205 |
| C-Tear, RT, Init., w/g, 6″/min | | | | | | | | |
| crosshead speed | | | | | | | | |
| Load at Max.Load (lbs) | 28.05 | 22.79 | 24.30 | 25.05 | 21.05 | 26.29 | 23.18 | 24.65 |
| Load/Thick at Max.Load (lbs/in) | 277.7 | 266.0 | 266.9 | 255.7 | 259.8 | 256.9 | 256.6 | 267.9 |
| Maximum Displacement (in) | 1.21 | 1.09 | 1.11 | 0.98 | 0.92 | 1.06 | 0.95 | 0.87 |
| C-Tear, 125° C., Init., w/g, | | | | | | | | |
| 6″/min crosshead speed | | | | | | | | |
| Load at Max.Load (lbs) | 9.0 | 9.8 | 9.2 | 9.0 | 9.4 | 11.0 | 11.2 | 10.0 |
| Load/Thick at Max.Load (lbs/in) | 87.8 | 96.7 | 92.6 | 101.5 | 104.4 | 106.7 | 109.8 | 111.7 |
| Tensile, Init., RT, w/g, | | | | | | | | |
| 6″/min crosshead speed | | | | | | | | |
| Maximum Stress (psi) | 3298 | 3431 | 3197 | 2892 | 2892 | 2572 | 2357 | 2266 |
| % Strain at Break (%) | 593.1 | 634.5 | 585.9 | 523.9 | 524.4 | 445.2 | 368.0 | 308.7 |
| Stress at 5% Strain (psi) | 118.5 | 115.9 | 124.4 | 131.0 | 154.8 | 223.2 | 332.7 | 531.0 |
| Stress at 10% Strain (psi) | 186.7 | 183.4 | 192.4 | 200.7 | 230.8 | 315.2 | 451.8 | 672.1 |
| Stress at 20% Strain (psi) | 292.7 | 287.6 | 298.9 | 307.1 | 344.3 | 439.5 | 590.0 | 821.6 |
| Stress at 25% Strain (psi) | 340.1 | 334.1 | 346.8 | 354.5 | 393.1 | 489.9 | 643.1 | 879.0 |
| Stress at 50% Strain (psi) | 542.9 | 536.2 | 547.1 | 551.1 | 585.7 | 622.4 | 764.1 | 966.8 |
| Stress at 100% Strain (psi) | 641 | 634 | 633 | 648 | 673 | 773 | 967 | 1219 |
| Tensile, Init., 125° C., w/g, | | | | | | | | |
| 6″/min crosshead speed | | | | | | | | |
| Maximum Stress (psi) | 1163 | 966 | 1141 | 1218 | 941 | 1265 | 1025 | 990 |
| % Strain at Break (%) | 170 | 150 | 165 | 167 | 142 | 161 | 140 | 124 |
| Stress at 5% Strain (psi) | 110 | 103 | 104 | 127 | 116 | 170 | 197 | 261 |
| Stress at 10% Strain (psi) | 193 | 182 | 179 | 213 | 195 | 264 | 288 | 362 |
| Stress at 20% Strain (psi) | 333 | 312 | 305 | 354 | 322 | 395 | 406 | 488 |
| Stress at 25% Strain (psi) | 392 | 366 | 357 | 408 | 368 | 429 | 431 | 510 |
| Stress at 50% Strain (psi) | 486 | 468 | 459 | 470 | 426 | 494 | 499 | 591 |
| Stress at 100% Strain (psi) | 657 | 627 | 613 | 651 | 646 | 805 | 771 | 628 |
| Shore A Hardness | 81 | 82 | 82 | 83 | 85 | 89 | 92 | 94 |
| Demattia Flex, 300 cpm, | | | | | | | | |
| 0.5 stroke, 125° C., x/g | | | | | | | | |
| Mean in/MMcycle | 82 | 39.9 | 18 | 9 | 7 | 9 | 11 | 15 |
| Mean Mcycle/inch | 12.7 | 25.4 | 56.5 | 110.2 | 144.5 | 117.3 | 96.7 | 68.3 |

The organoclay range study results of TABLE 9 shows that the minimum in viscosity (for this ZDMA content) is at around 2-4 phr organoclay but does not rise significantly as organoclay concentration increases. Even at 24-32 phr organoclay, the viscosity is not significantly higher than the minimum. The modulus increases continuously across the range with organoclay concentration as elongation at break drops off after a maximum is observed at 1 phr. Tear appears unaffected and Shore A creeps up slowly with increasing organoclay. The DeMattia crack growth shows a consistent decrease with increasing organoclay and indicates that embodiments with 2 phr or greater organoclay would be particularly suited for use in belts. Therefore, the data indicate that, even with the viscosity effects, it is possible to tailor a desired modulus in a final belt by adjusting the organoclay concentration. This can be achieved with only minor effects on viscosity and moderate drops in elongation at break.

### EXAMPLES

### Organoclay Masterbatch in Sulfur-Cured Belt Compositions

Further experiments were done using organoclay masterbatch in sulfur-cured belt compositions. A design study was utilized to investigate interactions by looking at a number of different samples having varied ZDMA or ZnO and organoclay masterbatch concentrations. These experiments are presented below. These examples indicate that organoclay masterbatch is a beneficial additive to sulfur-cured belt compositions and that the properties of an organoclay masterbatch belt composition can be further manipulated by changing the organoclay masterbatch concentrations in the final belt composition.

Nine embodiments of organoclay masterbatch in sulfur-cured belt compositions were investigated in detail. The final concentration of organoclay in a particular belt composition was controlled by varying the amount of masterbatch incorporated during mixing. The ZDMA or ZnO was introduced in the polymer and its concentration was controlled directly at the polymer mixing stage.

TABLE 10 shows the recipe for the masterbatch created containing organoclay in EPDM. This masterbatch was mixed prior to being combined with the rubber that contained the ZDMA. The masterbatch could be formulated using a sulfur-based coupling agent in place of the vinylsilane coupling agent with equal or better results.

TABLE 10
Organoclay/EPDM Masterbatch Recipe

| Material | PHR |
|---|---|
| EPDM | 100 |
| Maleated Polybutadiene | 6 |
| Organoclay | 44 |
| Vinylsilane Coupling Agent | 8 |

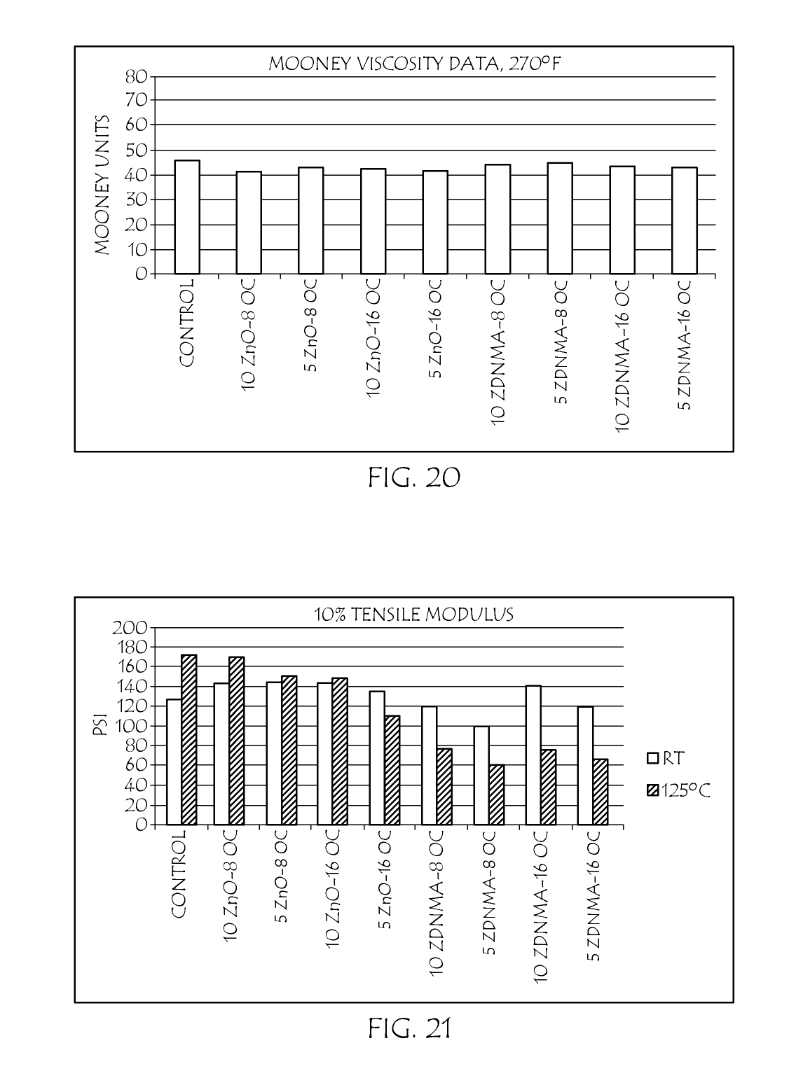

The general final rubber compound (the rubber with the masterbatch included) for each of the samples used for the testing is provided in TABLE 11 and the specific variations for each embodiment is provided in TABLE 12. Selected data from the testing of the embodiments of TABLE 12 are provided in FIGS. 20-28B.

TABLE 11
General Rubber Recipe

| Material | PHR |
|---|---|
| EPDM | 100 |
| Nylon flock | 4.76 |
| ZDMA | Variable |
| Carbon Black (N550) | 60 |
| Oil 7267 (Sunpar) | 7 |
| AO 4009 (Agerite Resin D) | 2 |
| ZnO | Variable |
| Stearic Acid | 1 |
| Sulfur | 2 |
| Organoclay/EPDM | Variable |
| Masterbatch of TABLE 10 | |
| TMTD | 1 |
| CBS | 1 |
| DPTT | 1 |

Mixing:

The following mixing procedures were used for the B Banbury mixer. Organoclay masterbatch-single-pass mix: (Rpm—75, Ram—30, Water—On, Front Roll—145° F., Back Roll—135° F.); 0′—Added ½ poly, fillers, chemicals and ½ poly, 1′—Scrape, 2′ (and every 2′)—Scrape, 10′—Dump.

All variables ran 10′ and dumped @ 194-228F (probe 258° F.).

First pass: (Rpm—65, Ram pressure—30 psi, Water—50° F., Front roll—80° F., Back roll—80° F.); 0′—add all but fiber and oil, 1′—add fiber, 190° F.—lift, scrape, 230° F.—add oil, 260° F.—lift, scrape, 275° F.—dump.

Samples ran 10′ and dumped @ 210-219° F. (probe 275-318° F.).

Final Pass: (Rpm—35, ram pressure—30 psi, Water—50° F., Front roll—80° F., Back roll—80° F.); 0′—Added all (sandwich curatives), 30″—lift, scrape, 4′ or 225° F.—dump.

All variables ran 3′-4′ and dumped @ 152-186° F. (probe 218-253° F.).

Testing:

The testing conducted here would be considered typical testing for rubber compounds. This includes Rheology (MDR, Mooney, RPA), tensile, C-Tear, DeMattia crack growth, Monsanto Fatigue-to-failure, Compression set and Shore A hardness.

Results and Discussion:

To evaluate the interaction between organoclay masterbatch, ZDMA and zinc oxide, a simple, two-factorial design was devised for each zinc source. The design series is shown in TABLE 12. The compounds were all mixed using the same procedure and the resulting compounds were evaluated using the tests described in the Experimental section. Standard analysis was conducted to determine the nature of the interaction for each property (the model type that fits the data).

TABLE 12
Sulfur-Cured Design Samples

| | Sample ID | | | | | | | | |
|---|---|---|---|---|---|---|---|---|---|
| | 1 | 2 | 3 | 4 | 5 | 6 | 7 | 8 | 9 |
| ZDMA (phr) | 0 | 0 | 0 | 0 | 0 | 10 | 5 | 10 | 5 |
| Organoclay (phr) | 0 | 8 | 8 | 16 | 16 | 8 | 8 | 16 | 16 |
| ZnO (phr) | 5 | 10 | 5 | 10 | 5 | 0 | 0 | 0 | 0 |

FIG. 20 illustrates the Mooney viscosity data for organoclay masterbatch/ZDMA/ZnO embodiments in sulfur-cured samples. The viscosity value for the compounds with organoclay added are all below the control indicating a general reduction in viscosity from the organoclay.

FIG. 21 illustrates the 10% tensile modulus data for organoclay masterbatch/ZDMA/ZnO embodiments in sulfur-cured samples. The 10% modulus was increased when used with zinc oxide but lowered with zinc dimethacrylate. This is partially because of the role of zinc methacrylate in the sulfur cure.

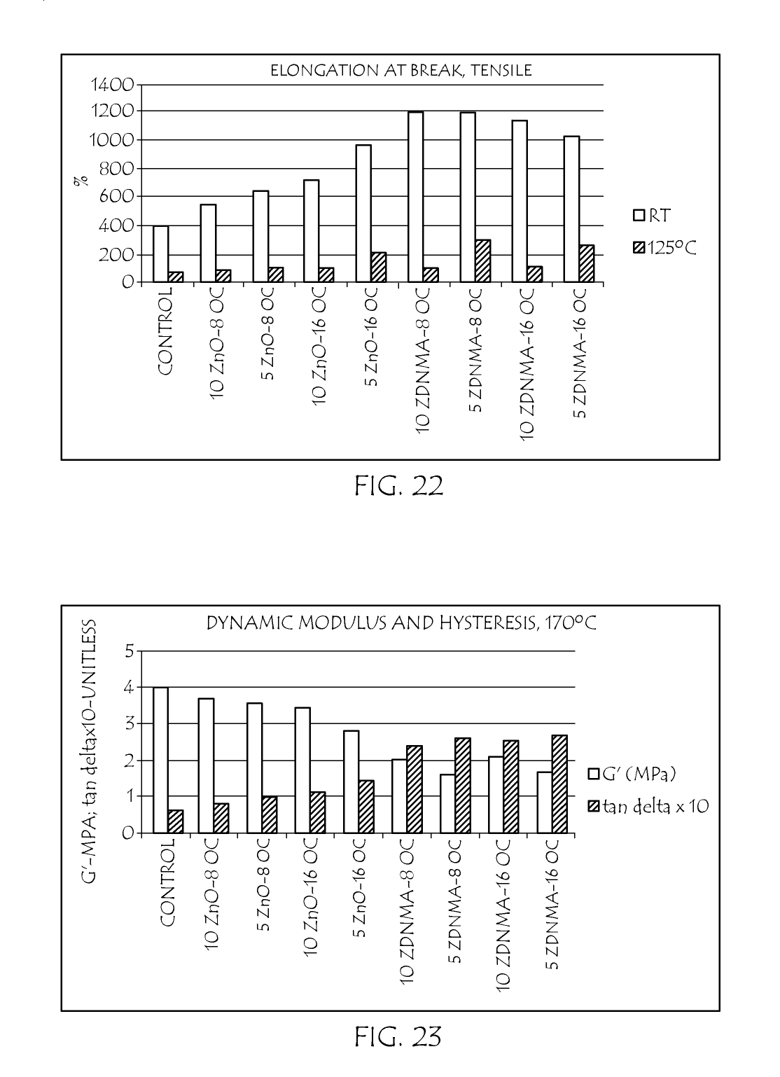

FIG. 22 illustrates the elongation at break data for organoclay masterbatch/ZDMA/ZnO embodiments in sulfur-cured samples. Elongation at break was up compared to the control sample for all the embodiments in this series. Because of the lower modulus for the ZDMA samples, the elongation at break was higher for those samples.

FIG. 23 illustrates the dynamic modulus data for organoclay masterbatch/ZDMA/ZnO embodiments in sulfur-cured samples. Dynamic modulus was lower for all the embodiments, more so for the embodiments with ZDMA.

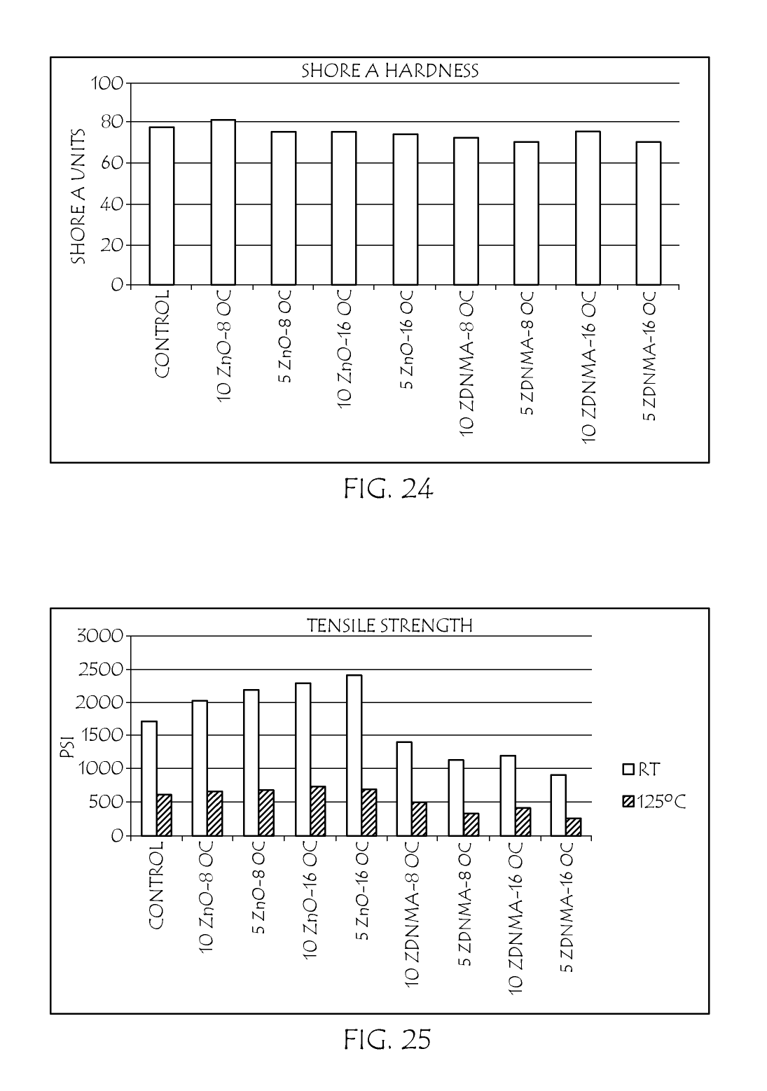

FIG. 24 illustrates the hardness data on the Shore A scale for organoclay masterbatch/ZDMA/ZnO embodiments in sulfur-cured samples. There were very small differences in Shore A values.

FIG. 25 illustrates the tensile strength data for organoclay masterbatch/ZDMA/ZnO embodiments in sulfur-cured samples. Tensile strength was improved for the ZnO samples while the ZDMA samples had lower values.

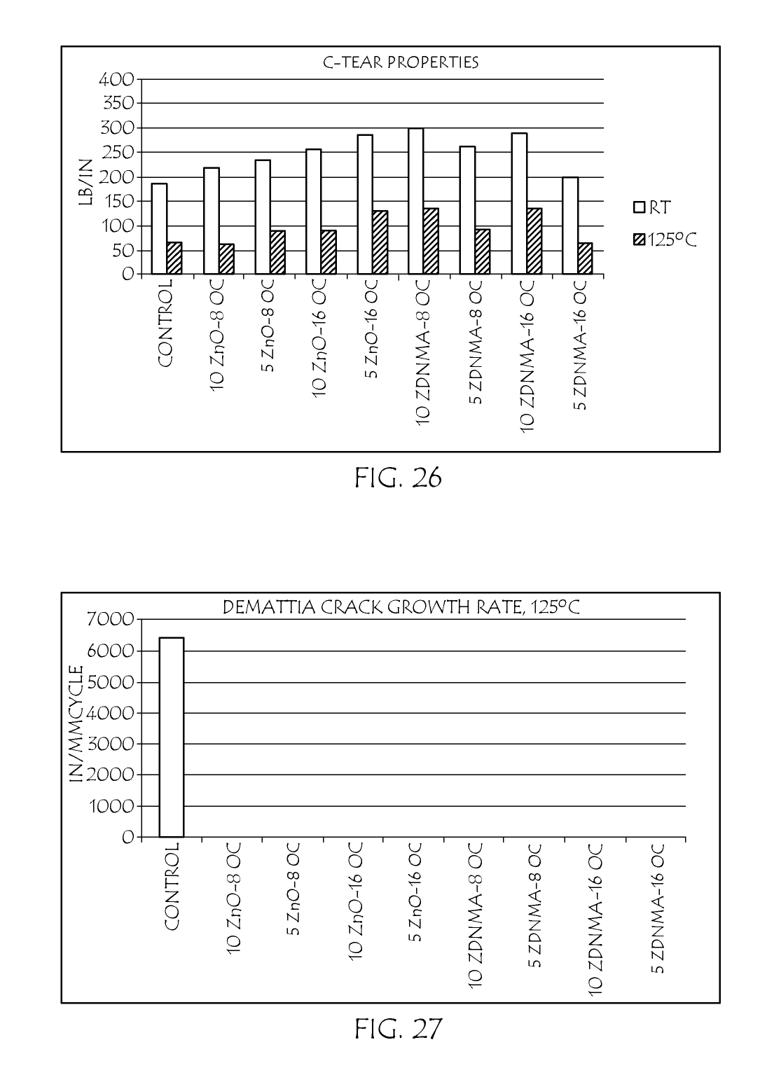

FIG. 26 illustrates the results of the tear properties test for organoclay masterbatch/ZDMA/ZnO embodiments in sulfur-cured samples. Tear was improved for all the organoclay samples.

FIG. 27 illustrates the results of the DeMattia crack growth rate test for organoclay masterbatch/ZDMA/ZnO embodiments in sulfur-cured samples. The crack growth rate is so low for all embodiments compared to the control that the embodiments are not discernable. The DeMattia results were 6440 Mean in/MMcycle for the control sample; 19.8 Mean in/MMcycle for the 10 ZnO-8 organoclay embodiment; 1 Mean in/MMcycle for the 5 ZnO-8 organoclay embodiment; and were not detectable (reported as 0 in/Mmcycle) for the rest of embodiments.

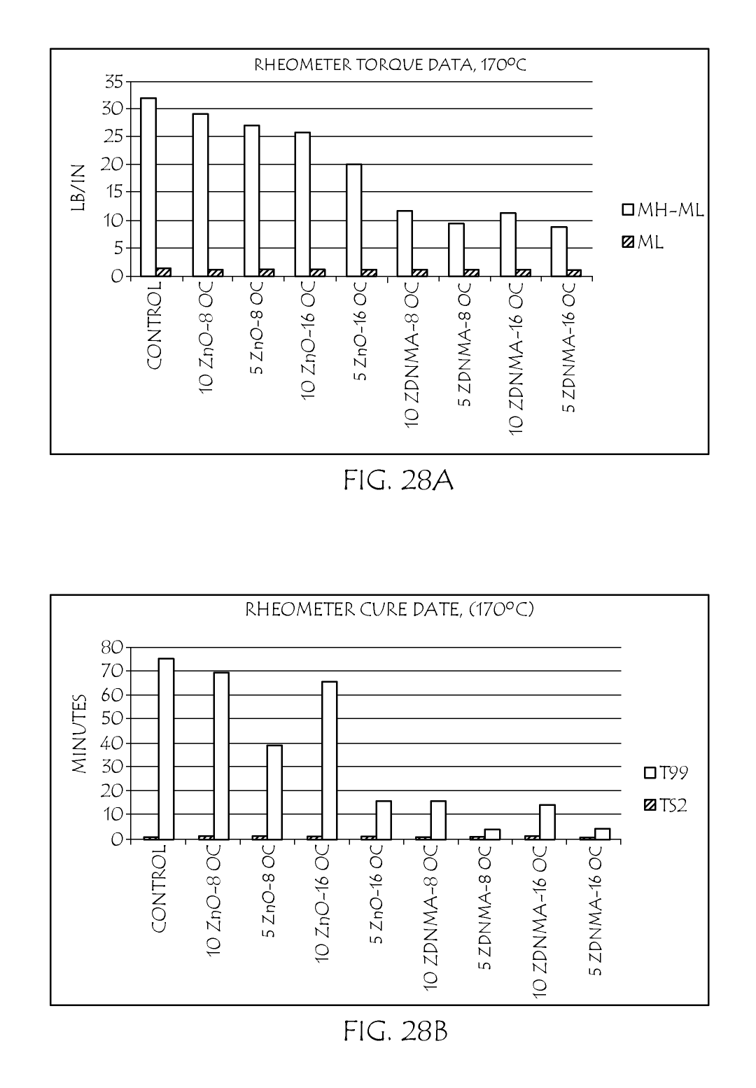

FIGS. 28A and 28B illustrate the Rheometer data for the organoclay masterbatch/ZDMA/ZnO embodiments in sulfur-cured samples. The Rheometer torque values were lower for all the organoclay embodiments but more so for the samples with ZDMA. Cure rates decreased with organoclay content. With ZDMA, the rate of cure was increased markedly. Increased zinc content usually slowed the cure rate.

The results of this testing and analysis of the two design sets in these compounds indicate that the organoclay has a more significant interaction with zinc oxide that zinc dimethacrylate in the sulfur-cured compounds. The organoclay provides many of the same properties discussed for the peroxide cure system. Modulus did not increase with organoclay inclusion when zinc dimethacrylate was the zinc source for the cure. This may require further optimization.

Although the organoclay masterbatch and its advantages, as well as the methods and resulting products have been described in detail above, it should be understood that various changes, substitutions, and alterations can be made herein without departing from the scope of the invention as defined by the appended claims. For example, the compositions described herein may be useful for any flexible article in which improving the crack growth resistance of the article in a specific direction is desirable, including cords, hoses, and bands.

Moreover, the scope of this disclosure is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized. For example, potentially suitable MSAs may be any zinc, cadmium, calcium, magnesium, sodium or aluminum salts of any of acrylic, methacrylic, maleic, ethacrylic and vinyl-acrylic acids. As another example, fibers such as fiberglass may be incorporated in any of the embodiments to further enhance the properties of the final products. In light of this disclosure, only routine investigation will be necessary to determine which embodiment or embodiments may be best for any particular rubber product or application and all such embodiments are adequately disclosed herein. Accordingly, the appended claims are intended to include within their scope such processes, machines, manufacture, compositions of matter, means, methods, or steps. The invention as claimed herein may suitably be practiced in the absence of any element that is not specifically disclosed herein.

What is claimed is:

1. A power transmission belt having an elastomeric belt body, said elastomeric belt body comprising:
an organoclay compatibilized using one or more maleated polymers, reactive silanes and metal salts of α-β-unsaturated organic acids.

2. The power transmission belt of claim 1, wherein the organoclay further comprises one or more of the following:
a) one or more of a smectite group material, a vermiculite group material or a kaolin group material.
b) wherein the organoclay is one or more of montmorillonite, aliettite, beidellite, ferrosaponite, hectorite, nontronite, pimelite, saliotite, saponite, sauconite, stevensite, swinefordite, volkonskoite, yakhontovite, and zincsilite.
c) wherein the organoclay is primarily montmorillonite modified using an ammonium salt.
d) wherein the organoclay is primarily montmorillonite modified using a dihydrogenated tallow dimethyl ammonium salt.
e) wherein the organoclay includes montmorillonite modified using a dihydrogenated tallow dimethyl ammonium salt as a surface modifier and having a surface modifier concentration of about 34-36 wt %, a particle size of about 14-18 microns, and a specific gravity of about 1.5-2.0 grams/cubic centimeter.

3. The power transmission belt of claim 1, wherein the power transmission belt has a circumferential axis and a radial axis, and the organoclay additive is composed of substantially thin, planar particles of organoclay distributed throughout the elastomeric belt body and wherein the planar particles are oriented so that the plane of each of the particles is substantially perpendicular to the radial axis of the elastomeric belt body and substantially parallel to the circumferential axis.

4. The power transmission belt of claim 1, wherein the metal salt of α-β-unsaturated organic acid is selected from zinc, cadmium, calcium, magnesium, sodium or aluminum salts of any of acrylic, methacrylic, maleic, ethacrylic and vinyl-acrylic acids.

5. The power transmission belt of claim 1, wherein the metal salt of a α-β-unsaturated organic acid is zinc dimethacrylate and the elastomeric belt body is primarily made of ethylene propylene diene terpolymers (EPDM).

6. The power transmission belt of claim 1, wherein the metal salt of a α-β-unsaturated organic acid is zinc diacrylate and the elastomeric belt body is primarily made of hydrogenated nitrile butadiene rubber (HNBR).

7. The power transmission belt of claim 1, wherein the power transmission belt is one of a multi-V-ribbed belt; a notched V-belt; or a toothed belt.

8. A power transmission belt having an elastomeric belt body, said elastomeric belt body comprising:
one or more elastomeric compounds;
a metal salt of α-β-unsaturated organic acids (MSA);
a maleated polymer;
a reactive silane; and
a organoclay additive.

9. The power transmission belt of claim 8 further comprising:
100 phr of the one or more elastomeric compounds;
5-50 phr of a MSA selected from zinc dimethacrylate and zinc diacrylate;
0.25-1.25 phr of maleated polybutadiene as the maleated polymer;
0.3-1.5 phr of vinylsilane; and
at least 2 phr of the organoclay additive.

10. The power transmission belt of claim 9 further comprising:
100 phr of hydrogenated nitrile butadiene rubber (HNBR);
10-25 phr of zinc diacrylate;
0.5-1.0 phr of the maleated polybutadiene in the form of Ricobond 2031;
0.6-1.3 phr of the vinylsilane in the form of Dynasylan VTEO; and
3.5-7 phr of the organoclay additive in the form of Nanomer I.44PL2.

11. The power transmission belt of claims 9 and 10 wherein the organoclay additive is compatibilized in a masterbatch prior to mixing a final belt compound used to create the power transmission belt.

12. The power transmission belt of claim 11 wherein the organoclay additive is compatibilized by the maleated polybutadiene and the vinylsilane.

13. The power transmission belt of claim 9 further comprising:
100 phr of ethylene propylene diene terpolymers (EPDM);
6.9-28.1 phr of zinc dimethacrylate;
0.5-1.6 phr of the maleated polybutadiene in the form of Ricobond 2031;
0.33-1.05 phr of the vinylsilane in the form of Dynasylan VTEO; and
0.3-11.6 phr of the organoclay additive in the form of Nanomer I.44PL2.

14. The power transmission belt of claim 8 wherein the MSA is selected from zinc, cadmium, calcium, magnesium, sodium or aluminum salts of any of acrylic, methacrylic, maleic, ethacrylic and vinyl-acrylic acids.

15. A method of increasing crack growth resistance in a power transmission belt having a circumferential axis and a radial axis, the method comprising:
adding a first amount of organoclay additive to a rubber composition including a second amount of metal salt of α-β-unsaturated organic acids (MSA), wherein the organoclay additive is composed of substantially thin, planar particles and wherein the first amount of organoclay additive is selected based on the second amount of MSA in the rubber composition;
processing the rubber composition and organoclay additive to substantially align the planar of particles of organoclay so that the planes of the individual particles are substantially parallel to each other; and
forming the power transmission belt from the rubber composition and organoclay additive so that the planes of the individual particles are substantially parallel to each other and substantially perpendicular to the radial axis of the power transmission belt.

16. The method of claim 15 further comprising one or more steps selected from the following:
a) creating a masterbatch of a hydrogenated nitrile butadiene rubber (HNBR), a maleated polymer, a vinylsilane; and the organoclay additive.
b) adding the masterbatch to the rubber composition.

17. A power transmission belt having an elastomeric belt body, said elastomeric belt body comprising:
one or more elastomeric compounds;
a MSA selected from zinc dimethacrylate and zinc diacrylate;
a maleated polymer;
a reactive silane; and
a organoclay additive, wherein planes of the individual particles of organoclay are substantially parallel to each other and substantially perpendicular to the radial axis of the belt.

18. The power transmission belt of claim 17 further comprising:
100 phr of the one or more elastomeric compounds;
5-50 phr of a MSA selected from zinc dimethacrylate and zinc diacrylate;
0.25-1.25 phr of maleated polybutadiene;
0.3-1.5 phr of vinylsilane; and
at least 2 phr of the organoclay additive.

19. The power transmission belt of claim 18 further comprising:
100 phr of hydrogenated nitrile butadiene rubber (HNBR);
10-25 phr of zinc diacrylate;
0.5-1.0 phr of the maleated polybutadiene in the form of Ricobond 2031;
0.6-1.3 phr of the vinylsilane in the form of Dynasylan VTEO; and
3.5-7 phr of the organoclay additive in the form of Nanomer I.44PL2.

20. The power transmission belt of claim 18 further comprising:
100 phr of ethylene propylene diene terpolymers (EPDM);
6.9-28.1 phr of zinc dimethacrylate;
0.5-1.6 phr of the maleated polybutadiene in the form of Ricobond 2031;
0.33-1.05 phr of the vinylsilane in the form of Dynasylan VTEO; and
0.3-11.6 phr of the organoclay additive in the form of Nanomer I.44PL2.

21. The power transmission belt of claim 18 wherein at least some of the maleated polybutadiene, the vinylsilane, and the organoclay additive are first mixed into a masterbatch and the masterbatch then added to a polymer to generate a final belt compound from which the power transmission belt was made.

22. The power transmission belt of claim 19 wherein at least some of the maleated polybutadiene, the vinylsilane, and the organoclay additive are first mixed into a masterbatch and the masterbatch then added to a polymer to generate a final belt compound from which the power transmission belt was made.

23. The power transmission belt of claim 20 wherein at least some of the maleated polybutadiene, the vinylsilane, and the organoclay additive are first mixed into a masterbatch and the masterbatch then added to a polymer to generate a final belt compound from which the power transmission belt was made.
